(19) United States
(12) Patent Application Publication
(10) Pub. No.: US 2011/0258467 A1
(43) Pub. Date: Oct. 20, 2011

(54) Leveraging a Power Distribution System to Provide a Mobile Marketing Platform

(76) Inventor: Vito Antoci, Newport Beach, CA (US)

(21) Appl. No.: 12/877,963

(22) Filed: Sep. 8, 2010

Related U.S. Application Data
(63) Continuation-in-part of application No. 12/769,530, filed on Apr. 28, 2010.
(60) Provisional application No. 61/326,175, filed on Apr. 20, 2010.

(51) Int. Cl. G06F 1/26; G05D 7/06

(52) U.S. Cl. 713/310; 700/297

(57) ABSTRACT

Some embodiments leverage a power distribution system to provide a mobile platform with which establishments can connect to users and provide targeted advertising and marketing to the user. Specifically, the power distribution system includes several distributed power stations and a server that authorizes access to power of each power station. Additionally, the power distribution system provide a mobile application that runs on an electronic device and that sends to the server a request to access power from a power station at a particular establishment. Through the mobile application, establishments can provide content that includes advertising, promotions, and other information to keep the users interested in the goods and services of the establishments. The advertising, promotions, and other information may be customized per user based on previous user information or activity that is logged by the mobile application.

### CLAIM OF BENEFIT TO RELATED APPLICATIONS

This application is a Continuation-In-Part of U.S. NonProvisional patent application Ser. No. 12/769,530, entitled “Portable Power Distribution”, filed Apr. 28, 2010 which claims the benefit of U.S. Provisional Application 61/326,175, entitled “Portable Power Distribution”, filed Apr. 20, 2010. The contents of Provisional Application 61/326,175 and NonProvisional patent application Ser. No. 12/769,530 are hereby incorporated by reference.

### TECHNICAL FIELD

The present invention relates to systems, methods, and devices to distribute power to recharge electronic devices on an advertising and/or fee basis.

### BACKGROUND

Portable electronic devices play a central role in the business and recreational lives of people. Portable electronic devices provide users with on-demand access to a multitude of functionality including communication, entertainment, information, and computing as some examples. These devices provide such functionality without restricting the mobility of the user.

Some examples of portable electronic devices include mobile telephones, smartphones, personal digital assistants (PDAs), tablet computing devices, laptop computers, portable music players, digital cameras, electronic gaming devices, and other battery operated devices. These devices are portable by virtue of the batteries that power the devices when on-the-go or away from a power source. However, the capacity of the batteries are limited and users often find themselves low on battery power due to excessive use, short battery life, forgetting to recharge the battery, or being away from a power source.

Many portable electronic devices store personal information and cannot be replaced when the battery runs out with a like kind device. One solution is to carry recharging equipment, such as a power adapter, to recharge the device. However, recharging equipment often involves (i) bulky adapters that are large or heavy, (ii) proprietary interfaces that can only be used to recharge a particular device and not other commonly carried devices, and (iii) incompatible specifications with electrical systems of different regions (i.e., different voltages 110V and 220V). Recharging equipment also requires that an available power source or power outlet be located nearby. In many areas where portable electronics are used (e.g., street, beach, airplane, park, etc.), power outlets are unavailable.

Some users purchase additional backup batteries to replace the primary batteries of the device in the event the primary batteries lose power. However, carrying extra batteries, like carrying recharging equipment, becomes cumbersome. Batteries for larger electronic devices (e.g., laptop computers) are heavy and large. Other devices operate using non-standard batteries which require the user to purchase different proprietary backup batteries for different devices. The user then has to ensure that the backup batteries contain sufficient charge to power the device. A further problem is that some devices do not have interchangeable batteries.

Accordingly, there is a need to provide portable power that can be used to recharge many of the most common portable electronic devices irrespective of the availability of a power outlet, the availability of recharging equipment, or the location of the device. There is further a need to provide such power in a cost-effective manner such that users of the devices receive power when most in need of power.

### SUMMARY OF THE INVENTION

Some embodiments provide systems, methods, and devices for providing power to recharge portable electronic devices through a distributed network of portable power stations that provide power on an advertising and/or fee basis. A server controls the advertisement distribution and fee collection and facilitates the distribution of power from a network of portable power stations.

Each power station includes a lockable power supply, a code input interface, and multiple recharging interfaces. Each of the recharging interfaces of the power station can connect to a different charging interface of a portable electronic device to recharge the device. Power from the power supply is unlocked based on codes that are entered into the code input interface. In some embodiments, the codes include a sequence of numbers that are encoded to specify a time and duration for the power station to unlock and provide power to the portable electronic device. Each power station includes logic to validate an entered code and to extract the time and duration parameters from the user entered code.

The unlock codes for each of the power stations are generated at the server. The server includes (i) logic for generating the unlock codes, (ii) interfaces and storage for content providers to submit and manage advertisements, (iii) scheduling logic to disseminate targeted advertisements, (iv) a payment processor to receive payments, and (v) interfaces and storage for maintaining a location directory that identifies a location for each of the portable power stations.

The server receives from a communication enabled portable electronic device (e.g., smartphone) a request for power from a particular power station. The request may be submitted wirelessly through wireless voice or data networks or through wired voice or data networks. The request is submitted through a server hosted website, text message, email, or by following a sequence of audio prompts. In some embodiments, the server requests and receives login information, selection of a desired charging duration, and payment information from the requesting device. The server disseminates to the requesting device at least one advertisement followed by an unlock code that unlocks the power supply of the particular power station.

The advertisement includes some combination of visual, textual, or auditory message that is embedded within a feature rich internet website, multimedia messaging service (MMS) message, text message, email, or audio message. Advertisements of different lengths or multiple advertisements may be disseminated to the user based on the desired amount of power from the power supply. For example, the server disseminates a ten second advertisement for unlocking one hour of power from the power station and two fifteen second advertisements for unlocking three hours of power from the power station. The server may disseminate targeted advertisements to the portable electronic device by identifying a location associated with the particular power station from the location database.

In some embodiments, the server provides one or more advertisements and an unlock code without receiving payment information from the requestor. In some embodiments, the server receives and processes payment information from the requestor and sends the unlock code without any advertisements.

In some embodiments, the power stations are enhanced to include at least one of a magnetic stripe reader, WiFi extender, GSM extender, CDMA extender, and display. From the magnetic stripe reader, the power station is automatically able to obtain login information and billing information. Through the WiFi extender, user devices are provided high speed data connectivity where there is otherwise no access to a data network. Through the GSM and CDMA extenders, the user devices are provided access to cellular networks where there is otherwise no signal. The display is used to provide instructions, greetings, and advertisements.

Some embodiments further provide a mobile application through which features of the power distribution system and other establishments may be accessed. The mobile application can be used to access power from a power station by obtaining the unlock code for the power station. Additionally, the mobile application is used to connect users to various establishments and connect the establishments with the users. Specifically, the mobile application provides access to customized content and services of one or more establishments that the user has visited or is currently located at. In some embodiments, such customized content is identified based on previous user activity.

### BRIEF DESCRIPTION OF THE DRAWINGS

In order to achieve a better understanding of the nature of the present invention a preferred embodiment of the systems, methods, and devices for providing power to recharge portable electronic devices through a distributed network of portable power stations that provide power on an advertising or fee basis will now be described, by way of example only, with reference to the accompanying drawings in which:

FIG. 1 illustrates a power distribution system in accordance with some embodiments.

FIG. 2 presents an exemplary message exchange for unlocking the flow of power at a particular power station.

FIG. 3 presents an example of the website hosted by the server.

FIG. 4 illustrates an example of the redirected website in accordance with some embodiments.

FIG. 5 illustrates components of the server and their interaction with third parties in accordance with some embodiments.

FIG. 6 presents a process for submitting advertisements to the server in accordance with some embodiments.

FIG. 7 conceptually illustrates the targeted advertising performed by the advertisement scheduler in accordance with some embodiments.

FIG. 8 illustrates the distributed system architecture of some embodiments that utilize a third party advertisement server.

FIG. 9 presents a process for distributing unlock codes on an advertising basis in accordance with some embodiments.

FIG. 10 presents a process for distributing unlock codes on a fee basis in accordance with some embodiments.

FIG. 11 presents a process performed by the code generator for generating an unlock code for a particular power station.

FIG. 12 illustrates an example of a request for an unlock code and an encoded unlock code generated by the code generator in accordance with some embodiments.

FIG. 13 presents a power station in accordance with some embodiments.

FIG. 14 presents the internal components of the power station in accordance with some embodiments.

FIG. 15 presents a process performed by the processor of the power station to unlock power in accordance with some embodiments.

FIG. 16 presents a process performed by the processor to validate an unlock code in accordance with some embodiments.

FIG. 17 illustrates the power station of some embodiments enhanced with a magnetic stripe reader.

FIG. 18 presents a process for performing an e-commerce transaction using a mobile application and the magnetic stripe reader of the power station in accordance with some embodiments.

FIG. 19 illustrates the power station of some embodiments enhanced with a WiFi extender.

FIG. 20 presents a process performed by the processor of the power station to unlock WiFi access and power in accordance with some embodiments.

FIG. 21 illustrates the power station of some embodiments enhanced with an embedded microcell or femtocell.

FIG. 22 illustrates the power station of some embodiments enhanced with a display.

FIG. 23 illustrates a power station of some embodiments.

FIG. 24 illustrates a home template for the mobile application in accordance with some embodiments.

FIG. 25 illustrates a combo wheel selectable item of the mobile application of some embodiments.

FIG. 26 presents a process for acquiring the mobile application of the power distribution system in accordance with some embodiments.

FIG. 27 illustrates an icon that is generated on the user device once the mobile application is installed.

FIG. 28 illustrates an enhanced power system architecture for providing customized content to the mobile application of a user device in accordance with some embodiments.

FIG. 29 presents a process performed by the mobile application to obtain location information from the user device in accordance with some embodiments.

FIG. 30 illustrates the mobile application prompting the user for permission to use the location based services in accordance with some embodiments.

FIG. 31 presents a process performed by the back-end integration manager to connect the mobile application of a particular user device to the appropriate establishment server in accordance with some embodiments.

FIG. 32 illustrates a prompt of some embodiments to confirm that the user device is at an identified establishment or some other establishment.

FIG. 33 illustrates the mobile application displaying targeted advertisements and promotions in accordance with some embodiments.

FIG. 34 presents a process for performing targeted advertising or marketing on the mobile application of a user device based on information that is stored on an establishment server in accordance with some embodiments.

FIG. 35 presents a process that is performed by the mobile application, back-end integration manager, and/or establishment server to track user activity and customize content that is provided to the mobile application based on the tracked user activity in accordance with some embodiments.

FIG. 36 illustrates some services that are accessible using the mobile application in accordance with some embodiments.

FIG. 37 illustrates content that is pushed to the mobile application of a user from one or more establishments that have a passive presence on the mobile application.

FIGS. 38 and 39 illustrate accessing pushed content using the mobile application.

FIG. 40 illustrates the mobile application display when the icon is selected in accordance with some embodiments.

FIG. 41 presents a process for pushing content from an establishment that has a passive presence to the mobile application on a particular user device.

FIG. 42 presents a preferences display of the mobile application from which the user can specify which establishments are provided a passive presence in accordance with some embodiments.

FIG. 43 illustrates an electronic device with which some embodiments are implemented.

### DETAILED DESCRIPTION OF THE INVENTION

In the following detailed description of the invention, numerous details, examples, and embodiments of the systems, methods, and devices for recharging electronic devices through a distributed network of portable power stations that provide power on an advertising or fee basis are set forth and described. However, it will be clear and apparent to one skilled in the art that these systems, methods, and devices are not limited to the embodiments set forth and that these systems, methods, and devices may be practiced without some of the specific details and examples discussed.

Portable electronic devices including mobile telephones, smartphones, personal digital assistants (PDAs), tablet computing devices, laptop computers, portable music players, digital cameras, electronic gaming devices, and other battery operated electronic devices rely on batteries for their portability. When on-the-go or away from a power source, the batteries provide up to a few hours of operation until the batteries have to be replaced, recharged, or the device is provided constant power through a power adapter of the device that is connected to a power outlet.

In many instances, users do not carry extra batteries or the power adapter when away from the home, office, or other location. Furthermore, a power adapter is useless when there are no nearby power outlets or the device is in a foreign location that has an electrical system that is incompatible with the power specifications of the device or power adapter.

Accordingly, some embodiments provide systems, methods, and devices for providing power to recharge portable electronic devices through a distributed network of portable power stations that provide power on an advertising and/or fee basis. Some such embodiments recharge the portable electronic device irrespective of the location of the device or whether the recharging equipment associated with the device (e.g., power adapter or necessary wiring) is readily available.

I. Power Distribution System

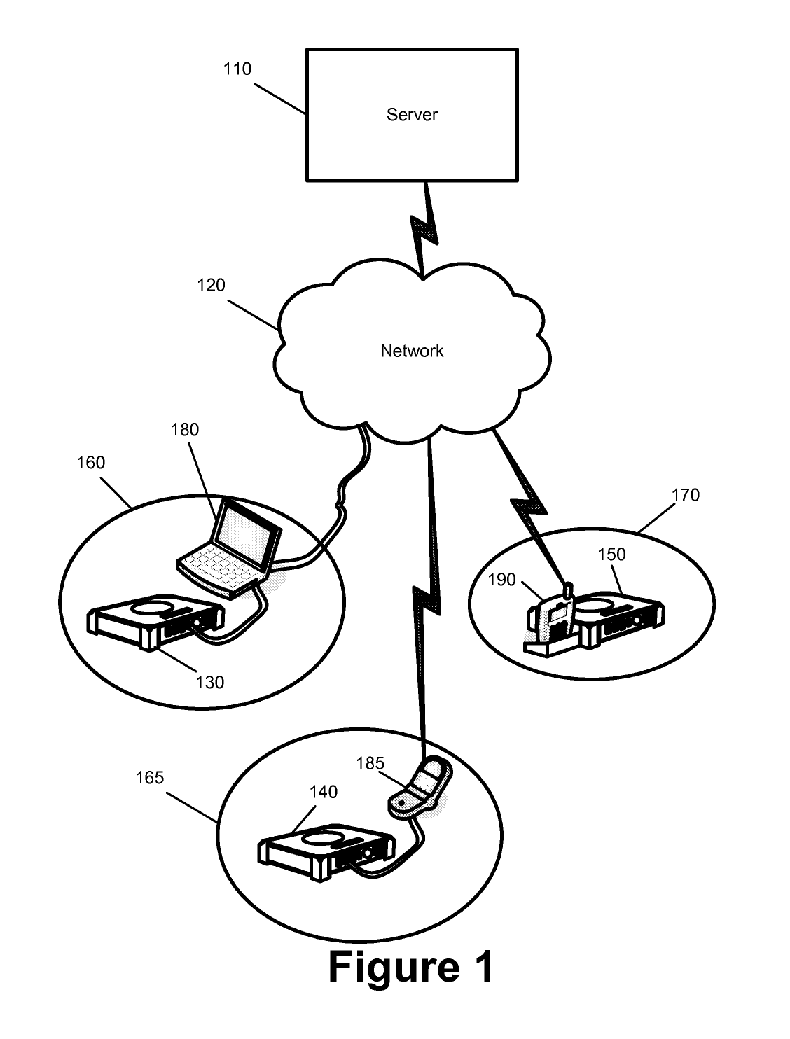

FIG. 1 illustrates a power distribution system in accordance with some embodiments. The power distribution system includes server 110, network 120, and a distributed set of portable power stations 130, 140, and 150. Each power station 130, 140, and 150 is located in a distinct region (e.g., regions 160, 165, and 170) from the other power stations though more than one power station may be included in any particular region. Each power station 130, 140, and 150 is assigned a unique identifier which is displayed on the device along with instructions for how to access power from the power station through the server 110. In some embodiments, the unique identifier identifies a region in which the power station is located. A region includes a business (e.g., hotel, coffee shop, etc.), location (e.g., park), or other area (e.g., city, state, municipality, zip code).

The power stations 130, 140, and 150 are docked on a docking station when not in use. The docking station recharges the power supply or battery of the power station. When the power station is needed to recharge a portable electronic device, the power station is removed from the docking station and brought to the device.

One of several charging interfaces of the power station can connect to charging interfaces of one or more devices in order to recharge the device. As shown, a portable electronic device (e.g., devices 180, 185, 190) is connected to each power station 130, 140, and 150 using one of several different interfaces of the power station. Through the connected interface, the power station provides power to recharge the connected device.

The interfaces include wired and wireless interfaces. In some embodiments, the wired interfaces include one or more ribbons that feed power from the power station to one or more docking ports located on a side of the power station. Each docking port contains a particular charging interface of a device (e.g., mini-USB) and a cradle to support the device when charging. The wired interfaces may also include a set of retractable cords each with a different interface connector at the end. The wireless charging interface includes an induction interface by which power is wirelessly transmitted to the battery of a portable electronic device.

In some embodiments, each power station 130, 140, and 150 provides a predetermined duration (e.g., twelve minutes) of free power before the flow of power is locked by the power station. To unlock the flow of power further, an unlock code must be entered on a code entry keypad of the power station.

Unlock codes are generated by the server 120. A portable electronic device requests an unlock code from the server 110 through the network 120. The request is conducted using the portable electronic device or some other communication enabled device that submits the request on behalf of the portable electronic device that needs to be recharged.

The network 120 includes any voice or data network. For example, network 120 includes the Internet, cellular voice networks (e.g., CDMA, TDMA, GSM, etc.), cellular data networks (GPRS, WiMAX, 3G and 4G data networks, etc.), messaging services, 802.11 based wireless networks, plain old telephone service (POTS), and other such communication networks.

The request may be submitted through a website managed by the server 110, a text message to the server 110, an email to the server 110, or by calling a particular number and following a series of audio prompts provided by the server 110. The request identifies a particular power station. The server 110 then requests the user to provide login information (e.g., user identification information and power station identifier), optionally select a duration for recharging, and optionally enter payment information before sending to the portable electronic device an unlock code that may be embedded within an advertisement.

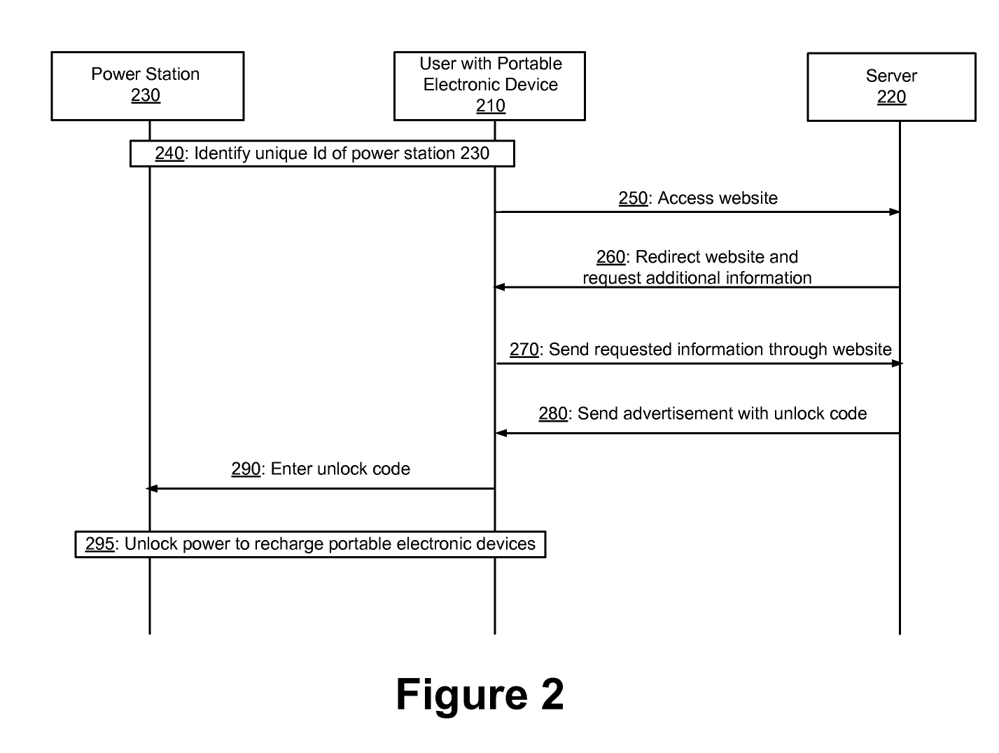

FIG. 2 presents an exemplary message exchange for unlocking the flow of power at a particular power station. The message exchange is conducted between a portable electronic device 210, server 220, and a particular power station 230.

To initiate a request to unlock power from the power station 230, the user of the portable electronic device 210 selects the particular power station 230 as the power station to recharge the portable electronic device 210. Imprinted on the particular power station 230 are instructions for how to unlock the power. The instructions may include a website address to access from the web browser of the portable electronic device 210, a number to send a text message based request to, or a number to dial in order to receive a set of audio prompts to unlock the device. The instructions also specify the unique identifier assigned to the particular power station 230 to identify the particular power station 230 to the server 220. For purposes of this example, it is assumed that the request is submitted by accessing a website hosted by the server 220.

The user identifies (at 240) the unique identifier assigned to the power station 230 and accesses (at 250) the website hosted by the server 220. When the portable electronic device 210 is not equipped with communication functionality (e.g., music player), another communication enable device may be used to submit the request on behalf of the portable electronic device 210.

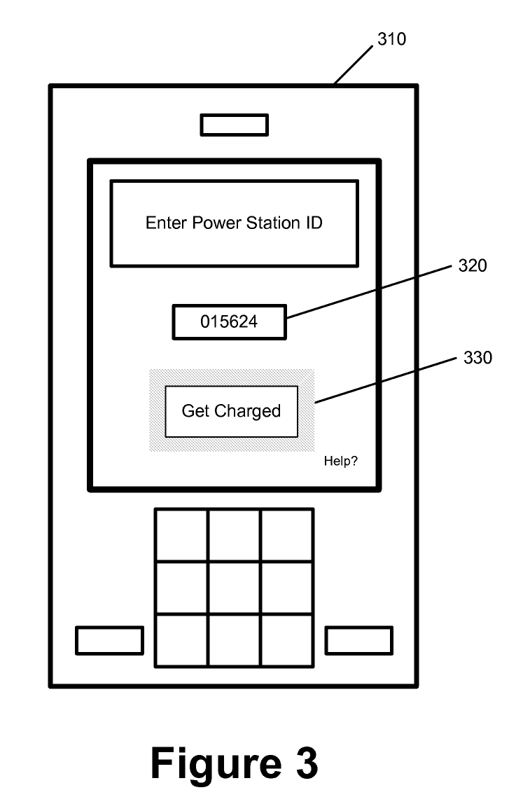

FIG. 3 presents an example of the website hosted by the server 220. The website is displayed on a display of a smartphone 310. The website contains a field 320 for the user to enter the unique identifier of the particular power station 230 and a button 330 to proceed.

In some embodiments, the server 220 receives the input and redirects the browser of the portable electronic device 210 to another website to request (at 260) additional information from the user. In some embodiments, the server requests (at 260) the user to enter login information (e.g., username and password) to identify the user, optionally select a duration to unlock the power station 230 for recharging, and optionally to enter payment information.

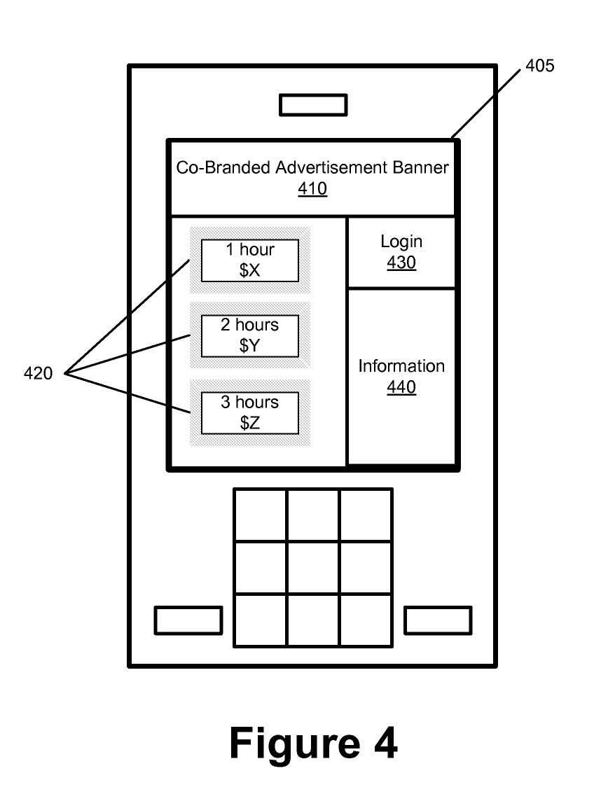

FIG. 4 illustrates an example of the redirected website 405 in accordance with some embodiments. As shown, the website 405 includes an advertisement banner 410, selection buttons 420 to specify a charging duration and the corresponding fee, login field 430, and other information fields 440. The user provides the requested information and submits the response (at 270) through the website.

In some embodiments, the website 405 is customized based on the power station unique identifier entered on the website of FIG. 3 above. The unique identifier identifies a particular location where the power station is hosted. Accordingly, the website 405 may be cobranded with advertisements, goods, services, and promotions for a business at the particular location. For example, if the power station is located at a particular hotel, the unique identifier allows some embodiments to customize the website 405 with special room rate promotions, spa deals, and hotel activities exclusive to the particular hotel.

It should be apparent that in some embodiments the website 405 includes additional or fewer fields that those depicted in FIG. 4. For example, the login field 430 may be presented on a later website after selection of a charging duration. Moreover, the website 405 may include a payment field though one may not be necessary when payment information is stored with a user account that is accessed using the login field 430. Additional websites may be presented after the website 405 in order to provide games, trivia, or other information to the user.

In some embodiments, the portable electronic device 210 may submit the request to unlock power from the particular power station 230 using alternate means of communication other than the web browser. For example, the request may be submitted using one or more text messages. An initial text message may be sent from the portable electronic device 210 to the server 220 with the unique identifier of the particular power station 230. A subsequent text message sent from the server 220 to the portable electronic device 210 may request additional information such as the login information or duration.

Upon receiving the information from the portable electronic device 210, the server 220 processes the information. In some embodiments, the processing includes validating the login information and billing a charge account of the user. Billing may occur using credit card information provided by or previously stored by the user, charging a room account of a hotel client, or by receiving a promotion code.

The server 220 selects one or more advertisements based on the user provided information and generates an unlock code. The server 220 embeds the unlock code at the end of the one or more selected advertisements. The server 220 sends (at 280) the selected one or more advertisements with the unlock code to the device 210. In some embodiments, the advertisements are sent directly through the website to be displayed on the portable electronic device 210, though alternate means of dissemination may include sending an MMS message, text message, or audio message. It should be apparent to one of ordinary skill in the art that in some embodiments the unlock code may be sent separate from the advertisement. In some such embodiments, the unlock code is presented after the advertising message.

The advertisements provide compensation to the power distribution system operator for operating the power stations and power distribution service. Specifically, the advertisements generate revenue directly from the advertisers, through the sale of goods and services promoted by the advertisements, or from referrals provided through the advertisements. Additionally, the proprietor of the power station may similarly be compensated through the advertisements for hosting the power station and providing a power distribution site.

The user receives the unlock code at the end of the advertisement, the user enters (at 290) the code on an input entry of the power station 230. The power station 230 begins providing (at 295) power for a specified duration to recharge the device 210 and any other devices connected to the charging interfaces of the power station 230. When the specified duration expires, the power station locks the flow of power preventing further recharging of the devices.

II. Server

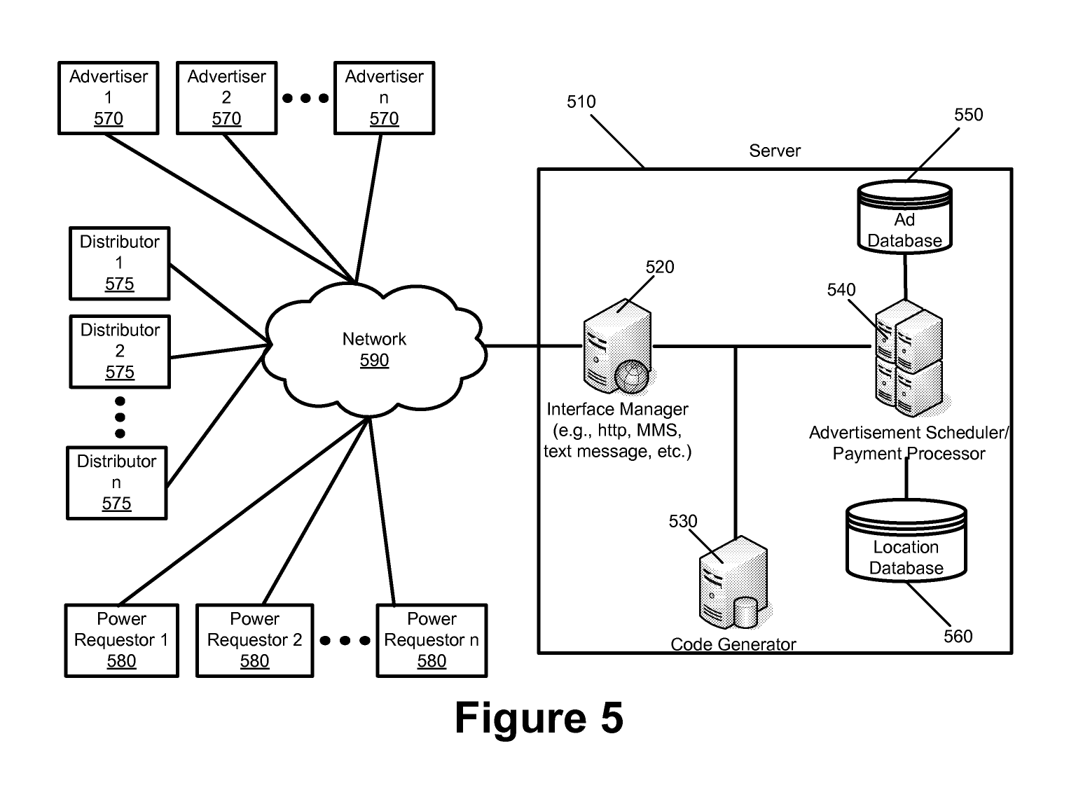

FIG. 5 illustrates components of the server 510 and their interaction with third parties in accordance with some embodiments. The server 510 includes an interface manager 520, code generator 530, advertisement scheduler and payment processor 540, advertisement database 550, and location database 560.

It should be apparent to one of skill in the art that the components of the server 510 (e.g., 520, 530, 540, 550, and 560) may include physical machines or logical components that are implemented on one or more physical machines. The physical machines may reside at a single location. Alternatively, the physical machines may reside at multiple physical locations whereby intercommunication between the machines is facilitated by the network 590.

The interface manager 520 acts as a point of contact for advertisers 570, distributors 575, and power requestors 580. Advertisers 570 include third parties that submit advertisements to be disseminated by the server 510. Distributers 575 include proprietors of the power stations and other parties that are purchasing, leasing, or hosting a power station. Power requestors 580 include users with portable electronic devices that need to recharge their devices.

In some embodiments, the interface manager 520 provides interactive interfaces to access services of the power distribution system. The interface manager 520 receives messages from the advertisers 570, distributors 575, and power requestors 580 and forwards the messages to either the code generator 530, advertisement scheduler and payment processor 540, or both. The interface manager 520 also sends messages received from the code generator 530 or advertisement scheduler and payment processor 540 to the advertisers 570, distributors 575, and power requestors 580.

The interface manager 520 provides interactive web pages that are accessible through the network 590 by any browser equipped device. Additionally, the interface manager 520 of some embodiments provides email, text messaging services, MMS services, and audio prompts as other forms of interactive interfaces through which advertisers 570, distributors 575, and power requestors 580 can access the services of the power distribution system of some embodiments.

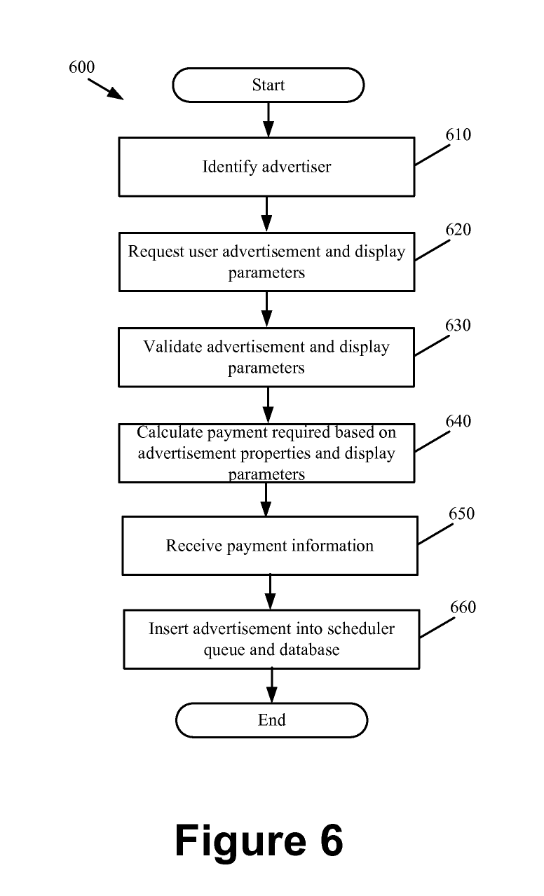

Advertisers 570 access the web pages to submit and manage advertisements that are disseminated to power requestors 580. The interface manager 520 presents the necessary web pages or other interfaces through which the advertisers 570 submit their advertisements and display parameters. The advertisements and display parameters are passed to the advertisement scheduler 540 and the advertisement database 550. FIG. 6 presents a process 600 for submitting advertisements to the server 510 in accordance with some embodiments.

The process 600 begins by the interface manager 520 identifying (at 610) an advertiser. In some embodiments, the interface manager 520 identifies an advertiser by requiring users that access the web pages to register and login. Users operating as advertisers register as an advertiser and subsequent logins identify the users as advertisers. Alternatively, the interface manager 520 of some embodiments may allow users to identify themselves as advertisers without registration or login. In some embodiments, advertisers 570 logon to different websites hosted by the interface manager 520 than the distributors 575 and power requestors 580.

The interface manager 520 requests (at 620) the advertiser to submit an advertisement and display parameters. Advertisements include audio messages, video messages, graphical messages, textual messages, or any combination thereof. Some examples of display parameters include how often the advertiser desires the advertisement to be disseminated (e.g., disseminate up to a certain price, disseminate twice a day, exclusive advertiser to one or more power stations, etc.) and the regional scope of the advertisement (e.g., a particular business, city, zip code, or nationwide).

The advertisement and display parameters are passed to the advertisement scheduler 540. The advertisement scheduler 540 validates (at 630) the advertisement and display parameters. In some embodiments, validation ensures that the advertisement is properly formatted. For example, validation requires that MMS messages are of a proper file type and the dimensions of an advertisement are suitable for display on displays of portable electronic devices.

The advertisement scheduler 540 calculates (at 640) a payment that is required to disseminate the advertisement based on the display parameters and the advertisement. The interface manager 520 prompts and receives (at 650) payment information from the advertiser. In some embodiments, an invoice is generated and sent to the advertiser. Other billing options include cyclical billing (e.g., monthly billing) or billing the advertiser account every time an advertisement is disseminated.

In some embodiments, video advertisements that run for a duration may be billed higher than text based advertisements. Additionally, the number of pending advertisements in the scheduling queue of the advertisement scheduler 540 may affect the price. For example, the advertisement scheduler 540 may increase the price for disseminating an advertisement during the holiday season as opposed to during off-peak seasons.

The advertisement scheduler 540 schedules (at 660) the advertisement for dissemination within an advertisement queue. The advertisement is stored (at 660) within the advertisement database where it can be retrieved for modification or dissemination and the process 600 ends.

Distributors 575 include power station hosts (e.g., hotels, coffee shops, libraries, etc.). In some embodiments, the power station system operator provides incentives for distributors to host the power stations. For example, a distributor purchases a power station at a fee but receives some of the advertising revenue generated by the power station until the distributor recoups the cost of the power station. Additionally, the distributor may continue receiving some of the advertising revenue or may use the power station as a means to promote other distributor provided services. For example, when users log on to the website of FIG. 4, the advertisement banner may be used to promote goods and services of the distributor (e.g., special hotel room rates, spa services, merchandise, etc.). Accordingly, the website of FIG. 4 may be customized based on the unique identifier of the power station entered on the website of FIG. 3.

Distributors 575 access the web pages of the interface manager 520 to purchase, lease, register, and manage power stations. Distributors 575 are businesses and individuals that operate one or more power stations. Collectively, the distributors 575 form the network of distributed power stations that is controlled by the server 510.

The distributors 575 register the power stations that they host by logging on to a website hosted by the interface manager 520 and providing the unique identifier of a power station that they operate and the location where the power station is hosted. The advertisement scheduler 540 uses the location information to disseminate targeted advertisements to portable electronic devices such that the content of the advertisements are relevant for the viewer. In this manner, distributors 575 may use the power station to exclusively promote their own business. For example, a distributor registers as an advertiser and requests that all advertisements sent to users requesting to unlock the distributor hosted power station contain messages that promote the distributor's own business (e.g., hotel activities, hotel specials, other hotel locations, etc.).

In some embodiments, the advertisement scheduler 540 provides targeted advertisements based on the unique identifier assigned to each power station. The unique identifier is provided within a user request to unlock a particular power station. The advertisement scheduler 540 queries the location database 560 to retrieve a location associated with the unique identifier. The advertisement scheduler 540 queries the advertisement database 550 with the retrieved location to identify one or more advertisements with display parameters that specify that the advertisement should be displayed at the identified location. The advertisement scheduler 540 passes the retrieved advertisement to the interface manager 520 from where it is disseminated to the requesting portable electronic device.

In some embodiments, the distributors 575 specify a rating for each power station that they host. The rating specifies the type of advertisements to be sent by the server 510 to clients of a particular distributor. Higher ratings specify higher end or exclusive clientele and lower ratings specify generic clientele. For example, a four-star hotel power station distributor may register all power stations hosted by the hotel with high ratings. When users of those power stations request unlock codes, the advertisement scheduler 540 uses the unique identifier assigned to those power stations to retrieve the rating information. The higher ratings associated with the unique identifiers cause the advertisement scheduler 540 to select advertisements intended for exclusive clientele only. In this manner, general advertisements or advertisements for low end products may be avoided.

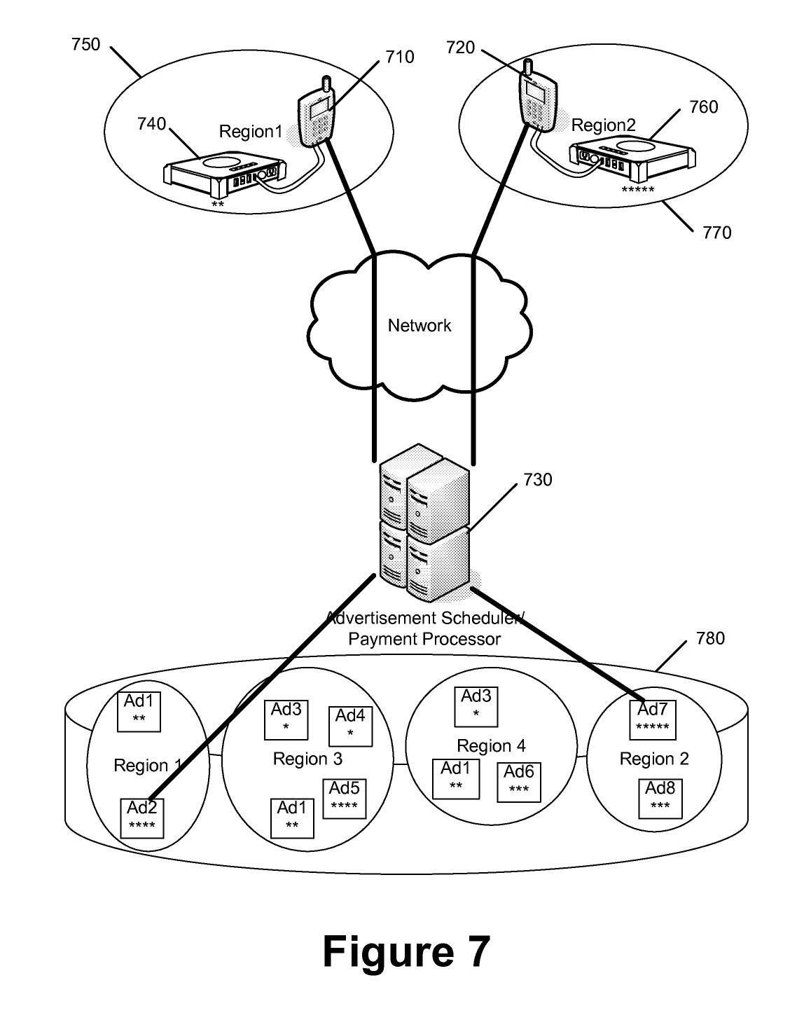

FIG. 7 conceptually illustrates the targeted advertising performed by the advertisement scheduler 540 in accordance with some embodiments. As shown, first and second devices 710 and 720 submit requests for power to the advertisement scheduler 730. The requests include the unique identifier of the first power station 740 located in the first region 750 and the unique identifier of the second power station 760 located in the second region 770. The first power station 740 is registered with a two-star rating and the second power station 760 is registered with a five-star rating. The first region 750 is separate from the second region 770.

The advertisement scheduler 730 receives the requests and identifies the regions and ratings associated with the unique identifiers of each power station from the locations database (not shown). The advertisement scheduler 730 queries the advertisement database 780 to identify advertisements associated with the first region 750 and advertisements associated with the second region 770. The advertisement scheduler 730 identifies Ad1 and Ad2 as advertisements that have display parameters specifying that these advertisements should be displayed to devices located in the first region 750. Similarly, the advertisement scheduler 730 identifies Ad7 and Ad8 as advertisements that have display parameters specifying that these advertisements should be displayed to devices located in the second region 770.

The advertisement scheduler 730 performs another query to the advertisement database 780 based on the ratings associated with each power station 740 and 760. Since the first power station 740 is associated with a two-star rating, Ad1 with a two-star rating and Ad4 with a four-star rating may be sent to the requesting device 710. However, the second power station 760 is associated with a five-star rating and therefore only Ad7 which also contains a five-star rating may be sent to the requesting device 720.

The advertisement scheduler 730 performs a scheduling algorithm to select between the advertisements associated with a particular region. For example, if Ad1 was the last advertisement to be disseminated from region 1, then the advertisement scheduler 730 selects Ad2 as the next advertisement to disseminate device 710 in region 1. For the second power station 760, only Ad7 specifies a rating equal to or greater than that specified for the second power station 760. Accordingly, the advertisement scheduler 730 selects Ad7 to disseminate to device 720. Ad2 is sent via the interface manager of the server to the first device 710 located in the first region 750 and Ad7 is sent via the interface manager of the server to the second device 720 located in the second region 770.

It should be apparent that some advertisements may be displayed across multiple regions. For example, Ad1 may be a national advertisement for a product that is associated with multiple regions as shown in FIG. 7 (i.e., regions 1, 3, and 4). Also, different power stations with different registered ratings may be located in a same region (e.g., premier hotel guests and regular hotel guests).

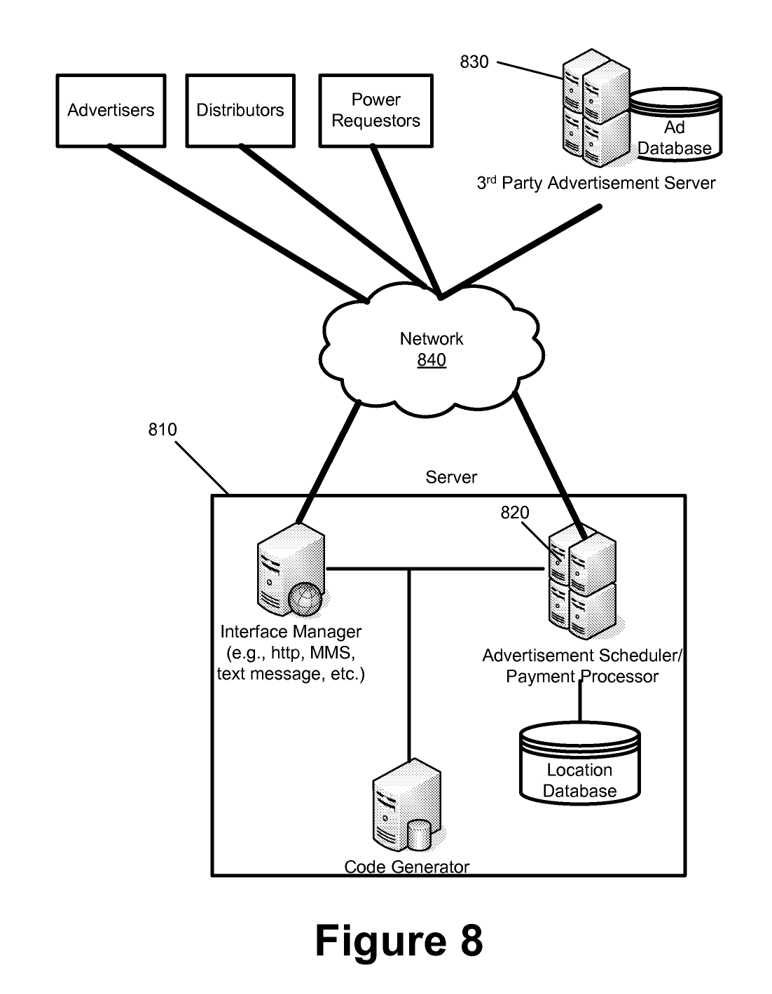

In some embodiments, the advertisements are provided by a third party advertisement server. FIG. 8 illustrates the distributed system architecture of some embodiments that utilize a third party advertisement server. As shown, the distributed power system server 810 no longer includes the advertisement database. Rather, the advertisement scheduler 820 communicates with a third party hosted advertisement server 830 through network 840 to obtain advertisements.

The advertisement scheduler 820 sends advertisement selection parameters to the advertisement server 830 and the advertisement server 830 returns advertisements that meet the parameters of the scheduler 820. In this manner, the advertisement scheduler 820 operates similar to the advertisement scheduler 540 of FIG. 5 by sending location information and rating information in order to receive targeted advertisements from the advertisement server 830.

With reference back to FIG. 5, power requestors 580 access the web pages of the interface manager 520 to request and receive unlock codes to unlock power from particular power stations. In some embodiments, power requestors 580 may submit requests for unlock codes through the interface manager 520 using a website hosted by the interface manager 520, a text message, an MMS message, an email message, or by following a series of audio prompts. In some embodiments, users receive the unlock codes from the interface manager 520 through the same communication means that were used to submit the request.

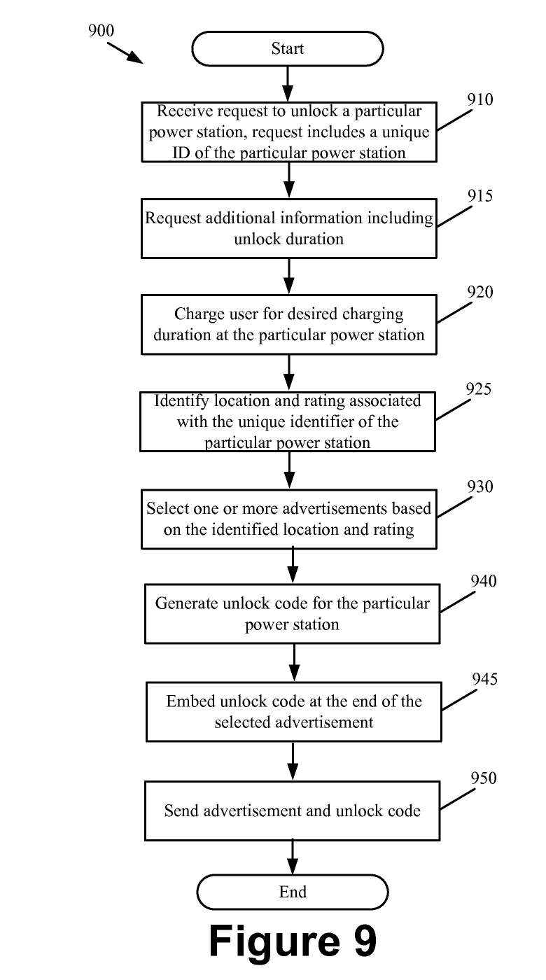

FIG. 9 presents a process 900 for distributing unlock codes on an advertising basis in accordance with some embodiments. The process 900 begins when the interface manager 520 receives (at 910) a request from a portable electronic device to unlock the flow of power at a particular power station. In some embodiments, the request includes the unique identifier of the particular power station. In some other embodiments, the interface manager 520 receives a request to unlock a particular power station without the unique identifier (e.g., logging on to the website of FIG. 3) and the interface manager 520 then prompts the user for the unique identifier.

The interface manager 520 requests (at 915) additional information from the user including a duration that the user desires to receive power to recharge his portable electronic device. Different durations require different fees with larger durations requiring larger fees. Accordingly, the request requires the user to submit login information that provides access to a user account with previously specified billing information. In some embodiments, the request requires the user to submit payment information.

The request passes from the interface manager 520 to the advertisement scheduler 540. The advertisement scheduler 540 charges (at 920) the user for the requested charging duration at the particular power station. As noted above, the user account may be billed, user provided credit card may be charged, a charge may be applied to a room or station where the user is staying, or a promotion code may be used in place of payment.

The advertisement scheduler 540 identifies (at 925) from the location database 560 the location of the particular power station associated with the unique identifier and any associated rating. The advertisement scheduler 540 selects (at 930) one or more advertisements based on the identified location and rating.

The interface manager 520 requests the code generator 530 to generate an unlock code. The code generator 530 generates (at 940) an unlock code for the particular power station and for a particular duration if one was specified in the request.

The selected advertisement and generated unlock code are passed to the interface manager 520. The interface manager 520 embeds (at 945) the unlock code at the end of the advertisement to ensure that the user views the full advertisement before receiving the unlock code. The interface manager 520 sends (at 950) the advertisement with the embedded unlock code to the requesting device and the process 900 ends.

In some embodiments, the interface manager 520 presents the advertisement with the embedded unlock on a web site that is displayed on the display of the requesting device. In some embodiments, the interface manager 520 sends the advertisement with the embedded unlock code to the requesting device via a text message, email, MMS message, or audio message.

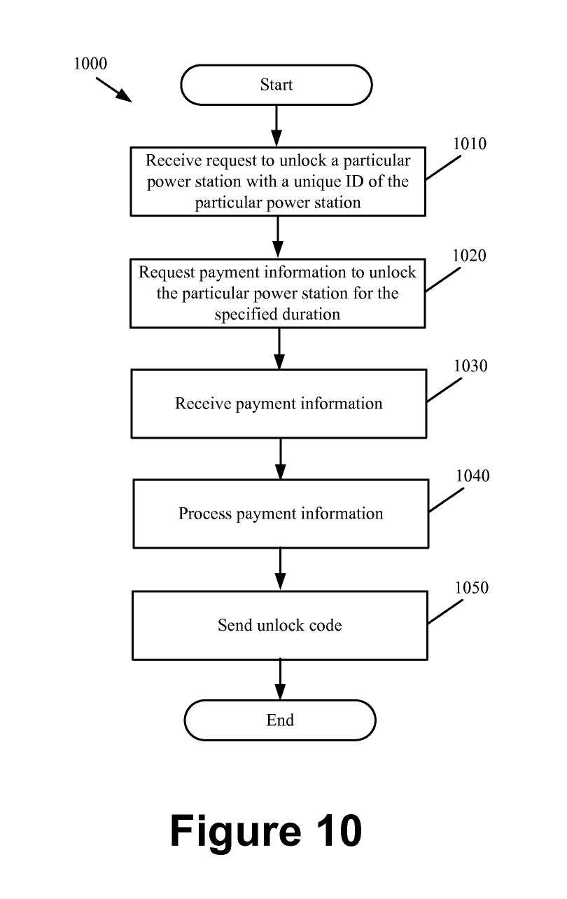

It should be apparent to one of ordinary skill in the art that in some embodiments payment information is optional and that the distributed power system operator and the power station host are compensated only through advertisement revenue. Moreover, some embodiments allow users access to the power of a power station without having to view advertisements. In some such embodiments, the users pay for the power that they acquire from the power station without receiving advertisements. FIG. 10 presents a process 1000 for distributing unlock codes on a fee basis in accordance with some embodiments.

As in FIG. 9, the process 1000 begins when the interface manager 520 receives (at 1010) a request from a portable electronic device to unlock power at a particular power station. The request passes from the interface manager 520 to the advertisement scheduler 540. In some embodiments, the advertisement scheduler 540 also performs payment processing. The advertisement scheduler 540 requests (at 1020) the interface manager 510 to obtain payment information from the user. The advertisement scheduler 540 receives (at 1030) the payment information and processes (at 1040) the payment information. Payment information may include credit card information or a user login that accesses an existing user account with payment information. The advertisement scheduler 540 requests the code generator 530 to send (at 1050) a generated unlock code through the interface manger 510 to the requesting device and the process 1000 ends.

It should be apparent to one of ordinary skill in the art that, though processes 900 and 1000 have been presented as separate processes, the server 510 may perform both processes using the same components (e.g., interface manager 510 and advertisement scheduler 540) or similar components. Accordingly, the server 510 allows some users to access power on an advertisement and fee basis, advertisement basis only, or fee basis only.

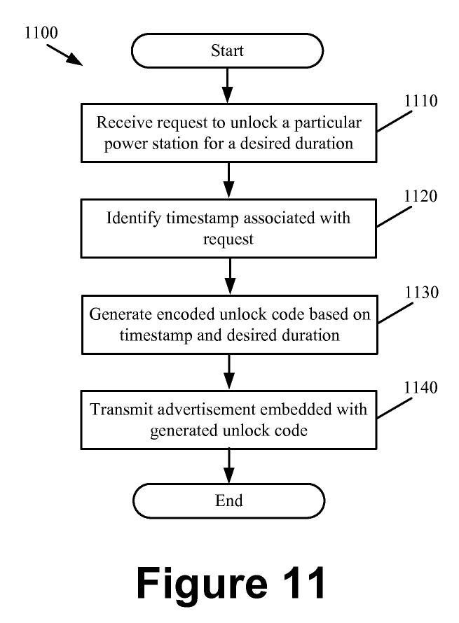

FIG. 11 presents a process 1100 performed by the code generator 530 for generating an unlock code for a particular power station. The process 1100 commences by the code generator 530 receiving (at 1110) a request to unlock a particular power station for a desired duration. The code generator 530 identifies (at 1120) a timestamp associated with the request (e.g., current time). The code generator 530 executes a code generation algorithm to generate (at 1130) an encoded unlock code based on the timestamp and the desired duration. The generated code is embedded with an advertisement that is transmitted (at 1140) to the requesting device through the interface manager 510 and the process 1100 ends.

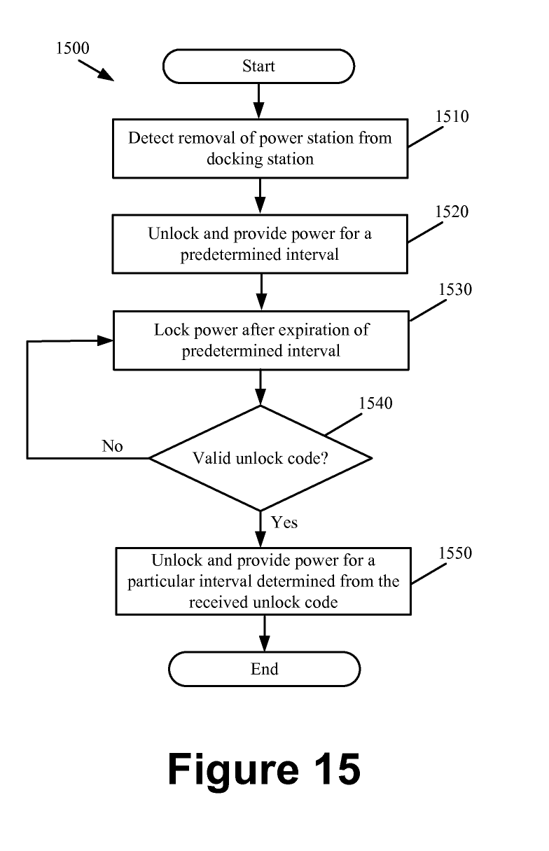

The unlock code is encoded so that the power station can validate the unlock code. This ensures that the user has viewed an advertisement or has paid to access power from the power station and that unauthorized users are prevented from accessing power from the power station. As described in further detail below with reference to FIG. 15, the power station executes a decoding algorithm to extract the timestamp and duration parameters from the encoded unlock code. If the extracted timestamp from a user entered unlock code is within a time threshold (e.g., ten minutes) of a current timestamp maintained by the power station, the power station unlocks the flow of power for the specified duration. However, if the encoded timestamp parameter is invalid, the power station knows that the user is improperly trying to access power from the power station without having viewed an advertisement or having paid to access the power. In such situations, the power station continues to lock the flow of power.

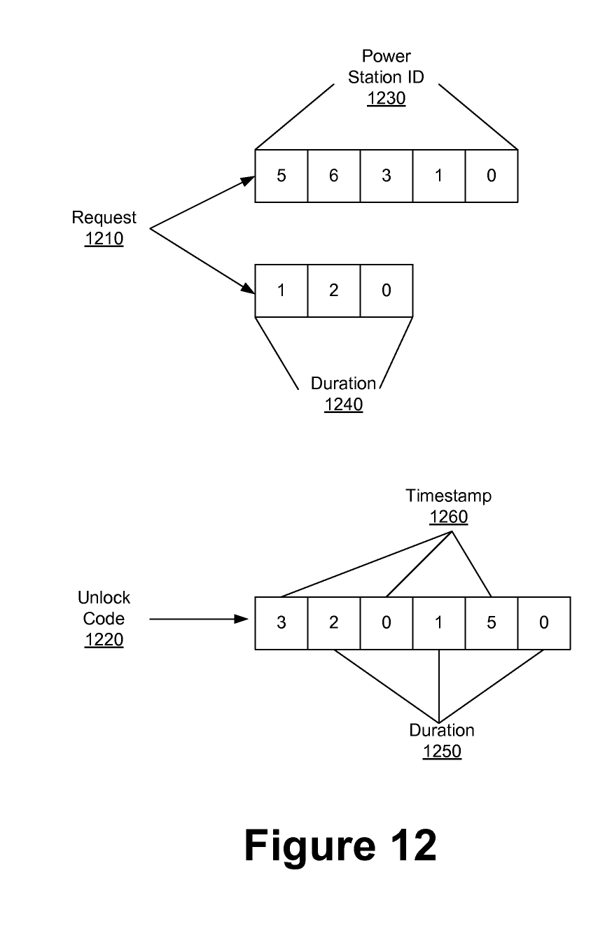

FIG. 12 illustrates an example of a request 1210 for an unlock code and generation of the encoded unlock code 1220 by the code generator 530 in accordance with some embodiments. The request 1210 includes the unique identifier of the power station 1230 which is depicted as a five digit number. The request 1210 further includes a three digit duration 1240 that specifies a desired amount of power in minutes (e.g., 120 minutes). It should be apparent to one of ordinary skill in the art that the request 1210 need not include the duration field when a default duration of power is provided by the power station. The sets of numbers 1210 and 1220 allow the request to be submitted using a web interface, email, text message, or audio prompts. However, it should be apparent that the request 1210 is exemplary of some embodiments and that some other embodiments may utilize a request of a different form or format.

The unlock code 1220 is presented as a six digit number with the three digits of the duration 1250 encoded with three digits of a timestamp 1260. The encoding is unrecognizable by a user and therefore control over the unlocking of the power stations is retained by the server 510. It should be apparent to one of ordinary skill in the art that the unlock code may include fewer or additional digits. For example, the unlock code may include a four digit timestamp. The timestamp may also be modified to include additional parameters for configuring the power station. For example, the voltage (e.g., 1.5V or 3V) or amount of current of the power station can be configured with the unlock code. In this manner, the power station can be configured to provide power within the power specifications of particular devices.

III. Power Station

Each of the power stations may be individually owned, operated, or leased from the distributed power system operator. The power stations are deployed across various regions in locales where it is advantageous to provide portable power to users with portable electronic devices. Accordingly, power stations may be located at hotels, coffee shops, restaurants, resorts, libraries, cruise ships, parks, or other such locations where power outlets may be unavailable, device power adapters are incompatible with electrical systems, or users are unlikely to carry power adapters or spare batteries with them.

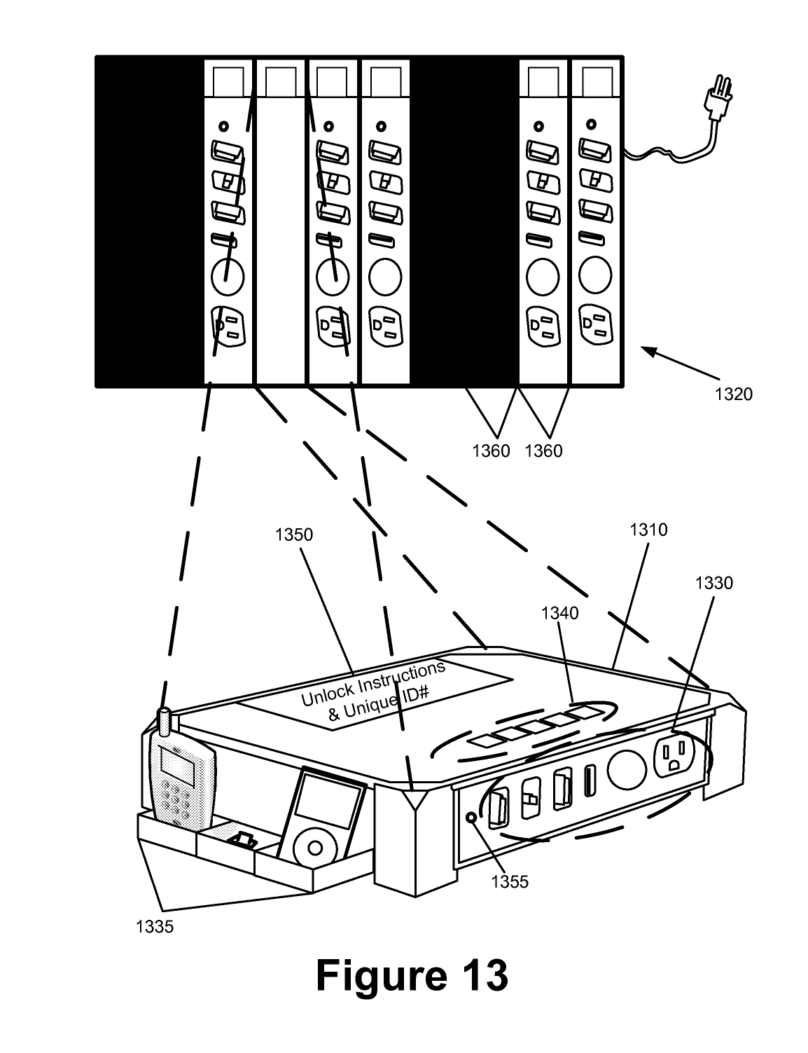

FIG. 13 presents a power station 1310 in accordance with some embodiments. The power station 1310 is extracted from a recharging station 1320. The power station 1310 includes wired device interfaces 1330, docking interfaces 1335, input entry 1340, instructions for unlocking power and a unique identifier for identifying the power station 1350, and a status indicator 1355.

The power station 1310 is housed within the recharging station 1320 when the power station 1310 is not in use. The recharging station 1320 includes a power cord that supplies power from a wall outlet to a battery or power supply of the power station 1310 through recharging slots 1360. The power from the recharging station 1320 recharges the power supply of the power station 1310 so that the battery of the power station 1310 remains charged and ready to be used to supply power to other portable electronic devices. In some embodiments, the recharging station 1320 includes ten recharging slots 1360 to recharge ten different power stations. When a user desires to recharge a portable electronic device, a power station is slid out from a recharging slot 1360 and transported to a user wherever the user may be located. When the user is done with the power station, the power station is slid back into a recharging slot 1360 where it is recharged.

The power station 1310 includes multiple wired interfaces 1330 to supply power to a variety of portable electronic devices with different charging interfaces. In some embodiments, each of the wired interfaces includes a retractable cord with a different interface connector at the end of the cord. The cord can be pulled out from the power station 1310 up to a distance of three feet and locked into position. A subsequent pull causes a spring loaded mechanism to retract the cord back into the power station 1310.

The power station 1310 further includes multiple docking interfaces 1335 to supply power to a variety of portable electronic devices with different charging interfaces. The docking interfaces 1335 include multiple cradles each with a different device charging interface. To recharge a portable electronic device using a docking interface 1335, the user slides the device into the cradle and the charging interface of the cradle attaches to the charging interface of the device. The power station 1310 is then able to transfer power from its power supply to the device. It should be apparent to one of ordinary skill in the art that some embodiments include only the wired interfaces 1330, some embodiments include only the docking interfaces 1335, and some embodiments include a combination of both.

In some embodiments, the wired interface 1330 and the docking interfaces 1335 include common interfaces such as a standard three prong outlet interface, a standard two prong outlet interface, any USB based interface (e.g., mini-USB, micro-USB, or standard USB), car cigarette lighter socket, and any Apple™ based interface used to interface with the iPod® iPod nano, iPod mini, iPhone®, iPad™, and other Apple products (e.g., the Apple 30 pin connector). It should be apparent to one of ordinary skill in the art that a particular power station may include more or less interfaces.

Additionally, some embodiments include an induction charging interface through which power is wirelessly transferred from the power station 1310 to a battery of a nearby device. In some such embodiments, the device to be recharged is placed on top of the power station 1310 or nearby and power is transmitted wirelessly to the battery of the device thereby recharging the device.

The portability of the power station 1310 allows recharging of portable electronic devices irrespective of where the device is located. For example, the power station 1310 may be transferred from a hotel lobby to poolside where the power station 1310 recharges a client's portable electronic device without requiring the client to be near a wall outlet or have the client bring a charging adapter.

In some embodiments, the power station 1310 provides a predetermined duration (e.g., twelve minutes) of free power when detached from the recharging station 1320. This free period temporarily revives a user device with no or little battery power and allows the user to request an unlock code using the device in order to receive further power to recharge the device.

The input entry 1340 provides a keypad through which users can enter an unlock code. In some embodiments, the input entry 1340 is a numeric keypad. The keypad may include separate keys for the numbers 0-9, may combine multiple numbers to a single key, or may include separate keys for fewer digits.

The status indicator 1355 presents status notifications to notify a user when a valid unlock code has been entered or when an invalid unlock code has been entered. Similarly, the status indicator 1355 may be used to notify users when the power supply is locked or unlocked. The status indicator 1355 includes a light that presents status by turning on the light, turning off the light, or flashing the light for different durations or speeds. The status indicator 1355 may also include audible notifications, such as beeps, to notify a user of various status changes.

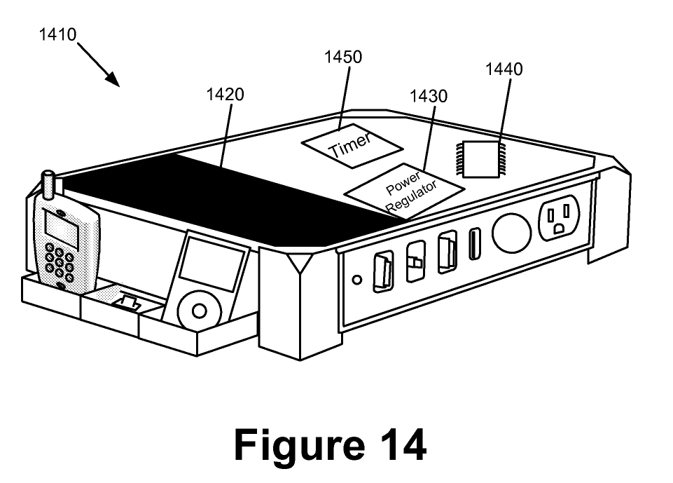

FIG. 14 presents the internal components of the power station 1410 in accordance with some embodiments. In FIG. 14, the power station 1410 includes a battery 1420, power regulator 1430, processor 1440, and timer 1450. The battery 1420 is a high capacity rechargeable battery capable of recharging multiple electronic devices for several hours. In some embodiments, the battery 1420 contains 36,000 mAh of power and has a cycle life of 500 cycles before the distributed power system operator replaces the batteries. However, it should be apparent that the battery 1420 may have a longer life cycle without impacting functionality of the power station.

The power regulator 1430 regulates the outflow of power from the battery 1420. In some embodiments, the power regulator 1430 regulates power according to the requirements of a device or electrical system of a country. For example, some countries utilize 220V electrical systems and portable electronic devices used in those countries require 220V for charging. Therefore, the power regulator 1430 provides power at 220V. Other countries utilize 110V electrical systems and portable electronic devices used in those countries require 110V for charging. Therefore, the power regulator 1430 provides power at 110V. The power regulator 1430 similarly regulates the current or amperage. Too little current or voltage and the device does not get charged. Too much current or voltage could damage the electronics or battery of the device.

In some embodiments, the power regulator 1430 contains a user adjustable switch with which a user can select a voltage and/or current suitable for the device to be charged. In some other embodiments, the power regulator 1430 automatically adjusts the voltage and current based on parameters detected from the device. Automatic adjustments may be made upon entry of an unlock code that contains a value specifying voltage and current specifications. These values may be encoded into the unlock code by having the interface manager of the server request the user to identify the device to be charged. The user identifies a make and model of the device and power settings associated with the device are encoded within the unlock code. Alternatively, the power regulator 1430 may utilize a default voltage and current that is safe for most portable electronic devices in the region in which the power station 1410 is located.

In some embodiments, the power regulator 1430 operates in conjunction with the processor 1440. For example, the processor 1440 decodes an unlock code with power settings and the processor 1440 adjusts settings of the power regulator 1430 based on the decoded values. The processor 1440 is also responsible for locking and unlocking power from the battery 1420 and processing unlock codes entered on the input entry keypad.

FIG. 15 presents a process 1500 performed by the processor 1440 of the power station 1410 to unlock power in accordance with some embodiments. The process 1500 begins when the processor 1440 detects (at 1510) that the power station 1410 has been removed from the docking station so as to provide a predetermined interval of free power. The processor 1440 uses the timer 1450 to unlock (at 1520) the flow of power from the battery 1420 for the predetermined interval. The processor 1440 identifies the end of the free power period when an interrupt is received from the timer 1450. The processor locks (at 1530) the flow of power from the battery 1420 preventing a device that is connected to any of the charging interfaces from receiving any further power until a valid unlock code is provided.

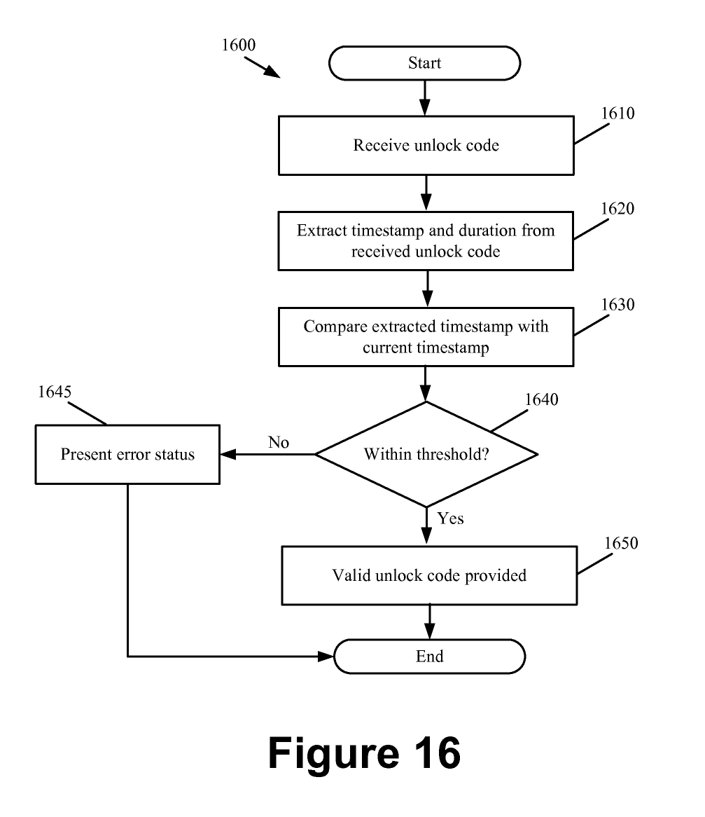

The processor 1440 identifies when a user enters an unlock code using the input entry and validates (at 1540) the provided unlock code. To validate the code, the processor 1440 performs the process 1600 as shown in FIG. 16.

Process 1600 begins when the processor 1440 receives (at 1610) an unlock code from the input entry. The processor 1440 executes a decoding algorithm to extract (at 1620) parameters from the user entered unlock code. In some embodiments, the processor 1440 extracts a timestamp value and a duration value. The timestamp value identifies when the unlock code was generated by the server. The duration value specifies how long to unlock the power station and provide charging to any devices connected to any of the multiple interfaces of the power station.

The processor 1440 compares (at 1630) the extracted timestamp value against a current timestamp value maintained by the timer 1450. Specifically, the processor 1440 verifies that the extracted timestamp value from the unlock code is within a time threshold (e.g., ten minutes) of the current timestamp value provided by the timer 1450. Accordingly, users have the time threshold from when they receive the unlock code from the server to enter the code into the power station.

When the extracted timestamp value is not within the threshold, the processor 1440 causes (at 1645) an error status indicator to become active and the process 1600 ends which further causes the processor 1440 to continue locking (at 1530) the power in process 1500 of FIG. 15. Otherwise, the processor 1440 has identified (at 1650) a valid unlock code which causes the processor 1440 to unlock (at 1550) power from the battery 1420 in process 1500 of FIG. 15. The processor 1440 sets the timer 1450 to provide power until the duration period extracted from the unlock code expires at which time the processor 1440 again locks power. The process 1500 ends unless another unlock code is entered or the power station is docked and undocked from the docking station.

It should be apparent that the processor 1440 performs additional functionality in addition to those described above. For example, the processor 1440 performs management functions for the power station such as controlling status indicators of the power station 1420.

Accordingly, some embodiments provide systems, methods, and devices for recharging electronic devices through a distributed network of portable power stations that provide power on an advertising or fee basis. In this manner, advertisers are provided a new medium through which to promote their businesses, products, and services. Users of portable electronic devices have an accessible and portable means through which they can recharge their portable electronic devices irrespective of their location, whether they brought their various charging adapters, whether they are carrying extra batteries, or whether they have funds to pay for the power. The power stations provide portable means for transporting power to the users. Moreover, the server ensures that an advertising and marketing system is in place to compensate the power distribution service provider as well as individual power station distributors and parties hosting the power stations. As a result, users no longer have to worry about their portable electronic devices running out of power.

IV. Power Station Enhancements

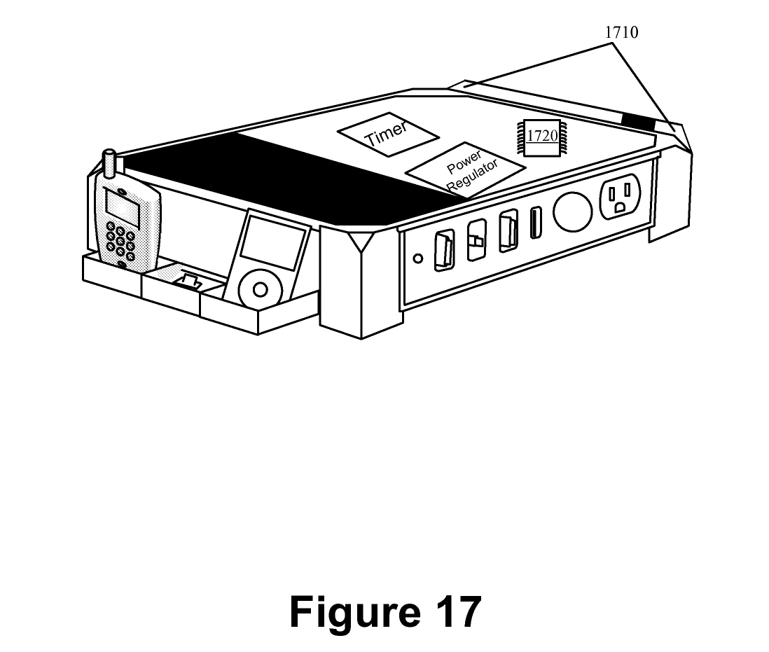

The power stations of some embodiments may be enhanced with additional functionality to supplement the lockable power supply and various charging interfaces that are described above. FIGS. 17-22 illustrate various enhancements to the power station that are in accordance with some embodiments. It should be apparent to one of ordinary skill in the art that a particular power station may include zero or more of these enhancements.

A. Magnetic Stripe Reader

FIG. 17 illustrates the power station of some embodiments enhanced with a magnetic stripe reader 1710. The magnetic stripe reader 1710 is located on the side of the power station. The magnetic stripe reader 1710 extracts information from one or more magnetic tracks of a swiped card where each track can magnetically store information. The magnetic stripe reader 1710 may include commercially available magnetic stripe readers with a USB or serial interface such as those provided by Tyner Incorporated or Plenar Technologies. The processor 1720 of the power station interfaces with the magnetic stripe reader 1710 using the USB or serial interface. From this interface, information that the magnetic stripe reader 1710 extracts from the tracks of a swiped card is passed to the processor 1720. The processor 1720 parses and decodes the extracted information to facilitate user identification, unlocking the power station, and e-commerce transactions.

In some embodiments, the processor 1720 of the power station is used to identify user identification information from a card that is swiped through the magnetic stripe reader 1710. The swiped card may include a driver's license, room key, membership card, or credit card as some examples of a card with a magnetic stripe that contains user identification information. The power station can use this information to facilitate user login or registration with the server of the power distribution system (i.e., server 110 of FIG. 1 and server 510 of FIG. 5). For example, when accessing the website from which to request an unlock code, the website may request the user to enter a username or password or swipe a card (e.g., driver's license, credit card, etc.) that contains user identification information through the magnetic stripe reader 1710 of the power station.

In some embodiments, the magnetic stripe reader 1710 facilitates e-commerce transactions. In some such embodiments, the user no longer has to enter payment information through a website or by using the keypad of the user device. Instead, payment information is provided by swiping a credit card, room key, membership card, or other card with billing information through the magnetic card reader 1710 of some embodiments. In this manner, users can quickly pay for unlocking power for a particular duration or purchase various goods and services as described in the sections below entitled “Mobile Application Marketing” and “Mobile Application Services”.

In some embodiments, the power station uses a network enabled user device to facilitate the transfer of information that is extracted from a swiped user card. After the processor 1720 parses and decodes the swiped card information, the processor 1720 interfaces with the user device in order to pass the information to the server of the power distribution system. In some embodiments, the processor 1720 passes the information to a mobile application of the power distribution system that is running on the user device. In some embodiments, the mobile application is running on the user device and, at the appropriate stage (e.g., at a login procedure or when completing requesting payment information), the mobile application begins polling the processor 1720 of the power station to obtain extracted card information. The mobile application then leverages the network connectivity of the user device to wirelessly transmit the information to the server through a wireless data network (i.e., GPRS). Specifically, the mobile application generates one or more packets that are wireles sly sent over the wireless data network to the server.

In some embodiments, the processor 1720 passes the information to the mobile application running on the user device through a wired charging interface that is connected to the user device. In many devices, the charging interface also provides a data transfer interface through which data can be sent to or received from the user device. For example, the USB, mini-USB, micro-USB interfaces as well as any Apple based interface can be used as a charging interface or a data interface to the user device. In some such embodiments, the processor 1720 encapsulates the extracted information in a message. The processor 1720 passes the message to the mobile application over the wired interface that connects the user device to the power station.

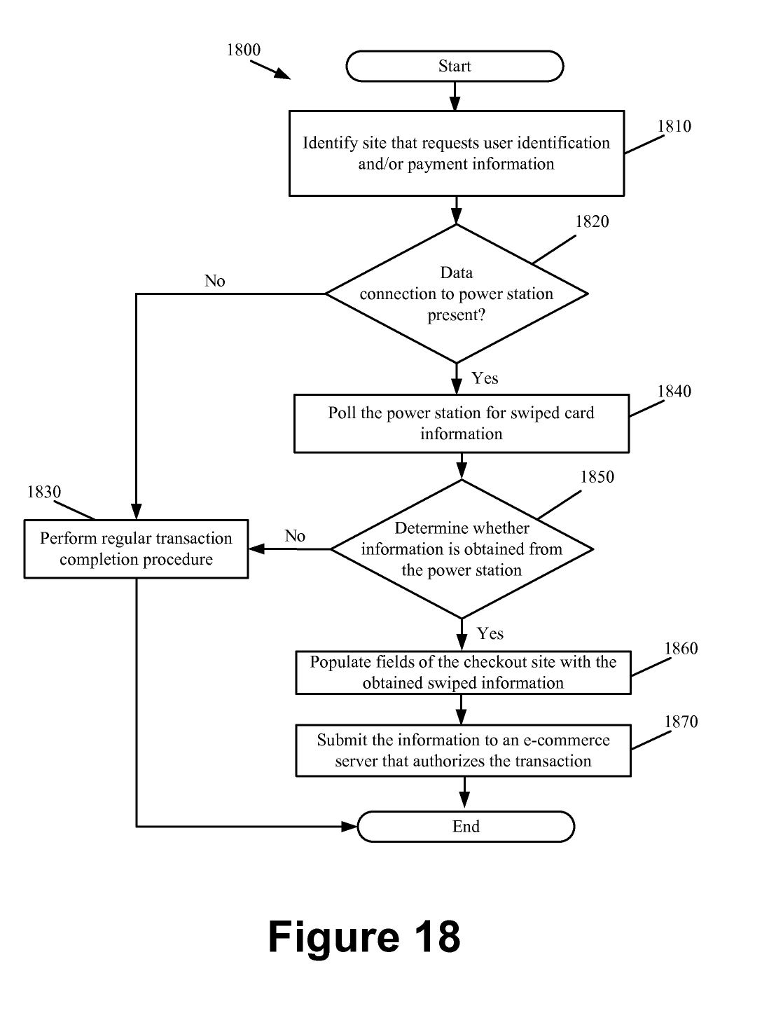

FIG. 18 presents a process 1800 for performing an e-commerce transaction using a mobile application and the magnetic stripe reader of the power station in accordance with some embodiments. The process 1800 begins when the mobile application is launched on the user device and the mobile application connects to an e-commerce site from which various goods and services may be purchased. The e-commerce site may include a site of the power distribution system or other Internet accessible e-commerce site from which the user can purchase goods or services. In some embodiments, the mobile application is a web browser application that runs on a user portable device. In some other embodiments, the mobile application is a proprietary application that is provided by the power distribution system as discussed in greater detail below with reference to Section V.

Using the mobile application, the user selects various goods or services to purchase and proceeds to the checkout site to complete the transaction. The process facilitates completion of the e-commerce transaction by identifying (at 1810) that a site that is displayed within the mobile application requests user identification and/or payment information. To do so, the process may determine that the site is a secured site (e.g., HTTPs) or the process can scan the site content to determine fields for entering user identification information or payment information. Next, the process determines (at 1820) whether a data connection is present from the user device to the power station. From the data connection, the process can interface with the power station and obtain data from that is extracted using the magnetic stripe reader of the power station.

When the data connection is not present (i.e., the user device is not connected to a charging interface of the power station), the process performs (at 1830) a regular transaction completion procedure whereby the user enters the identification information and billing information to complete the transaction using a keypad of the user device. However, when the data connection is present, the process may optionally prompt the user through the mobile application to swipe a card through the magnetic stripe reader of the power station. The process (at 1840) begins polling the power station for swiped card information. In some embodiments, the mobile application sends a set of messages over the data connection to the processor of the power station to request the any swiped card information. In some embodiments, the application opens a socket through which the processor of the power station can pass swiped card information to the application. Accordingly, when the user swipes a credit card or other card with identification and billing information, the processor extracts and parses the information as before and passes the information to the mobile application.

The process determines (at 1850) whether information is obtained from the power station. When no information is obtained, the user can continue to complete the transaction using the regular transaction completion procedure whereby information is manually entered through the keypad of the user device. However when a card is swiped and information is obtained from the power station, the process populates (at 1860) the fields of the checkout site with the obtained swiped information. Specifically, the process identifies which fields correspond to what data based on tags that identify data fields of the checkout site. In this manner, the process can populate the user's last name in a last name field and populate a credit card number in a credit card number field when such information is extracted from a card that was swiped through the magnetic stripe reader of the power station. The process then completes the transaction by using the network connectivity of the user device to submit (at 1870) the information to an e-commerce server that authorizes the transaction. In some embodiments, the user verifies the populated information before submission. In some embodiments, the user decides when to complete the transaction and submit the information providing an input to the application.

It should be apparent to one of ordinary skill in the art that the process 1800 may be adapted to facilitate completion of any e-commerce transaction, login, or registration procedure whereby the user would ordinarily provide identification information and/or payment information by entering such information through a keypad or other means of input on the user device. Using the enhanced power station with the magnetic stripe reader, the user can complete a transaction much more quickly and with less likelihood of error by simply swiping a card through the magnetic stripe reader while the user device is connected to the enhanced power station.

In some embodiments, the enhanced power station provides contactless extraction of card information using “blink” functionality. In some such embodiments, the power station is enhanced with a radio-frequency identification (RFID) terminal in addition to or instead of the magnetic stripe reader. The terminal wireles sly reads information from a card that is placed near the terminal where the card contains a radio-frequency ID microchip that is encoded with the information.

In some embodiments, the power station includes independent network connectivity through which the information that is extracted from the magnetic stripe reader 1710 or the RFID terminal is sent to the user device, server of the power distribution system, or other third party server. For example, the power station may include a broadband connection and a network protocol stack that facilitates the transfer of the extracted information from the power station to the server of the power distribution system.

B. Embedded WiFi Extender

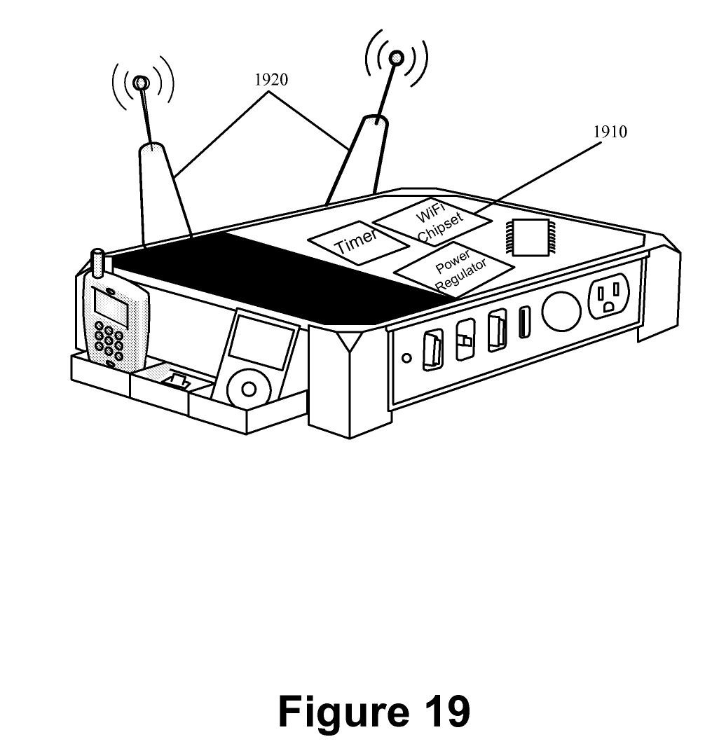

FIG. 19 illustrates the power station of some embodiments enhanced with a WiFi extender. The WiFi extender is implemented by embedding WiFi chipset 1910 and by including the antennae 1920. The WiFi extender boosts any nearby WiFi signals so that the user device can have access to high speed data services where there otherwise might be no signal or there is a signal that is insufficient to be picked up by the antenna of the user device. Specifically, the WiFi chipset 1910 and antennae 1920 create a WiFi radio receiver/transmitter that is able to detect signals that the WiFi radio receiver/transmitter of the user device cannot. The WiFi radio receiver/transmitter of the power station operates on the order of a few hundred to thousand milliwatts, whereas the user device WiFi radio receiver/transmitter operates on the order of tens of milliwatts. In this manner, the enhanced power station is able to provide a more powerful radio receiver/transmitter that better amplifies and therefore better detects distant signals.

In some embodiments, the WiFi signal is provided by the establishment that hosts the power station. Depending on the location of the user device, the WiFi signal may not be strong enough to facilitate data transmission through the user device (e.g., user device is poolside). However, the higher power WiFi radio receiver/transmitter of the power station can be used to amplify and to repeat the signal. In so doing, the power station boosts the WiFi signal to facilitate transmission of data between the user device and a router or switch from which the WiFi signal originates. Moreover, multiple such power stations with WiFi extending capabilities may be used together to create a wireless distribution system for users of a particular establishment when the particular establishments hosts multiple such power stations.

In some embodiments, the WiFi access is locked in conjunction with the lockable power supply of the power station. The user is provided access to the WiFi service and/or power from the power supply when the user unlocks the power station using the unlocking processes described above. In some embodiments, the power station enables the WiFi access for a short duration (e.g., 12 minutes) when the power station is removed from the docking station and delivered to the user. During this short duration, the user device has WiFi access such that the user can request the unlock code from the server using a webpage, mobile application, text message, or other data means.

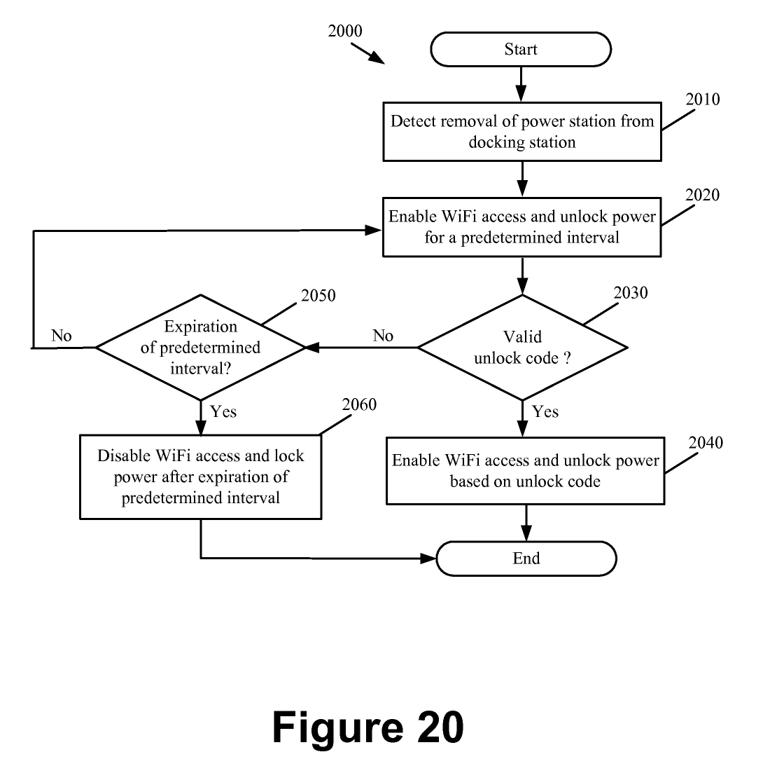

FIG. 20 presents a process 2000 performed by the processor of the power station to unlock WiFi access and power in accordance with some embodiments. As in FIG. 15 above, the process detects (at 2010) removal of the power station from the docking station. The process enables (at 2020) WiFi access and unlocks power for a predetermined interval. The process determines (at 2030) whether a valid unlock code was provided by the user using the keypad on the power station. When a valid unlock code is provided, the process enables (at 2040) the WiFi access and unlocks the power supply based on the provided unlock code. Otherwise, the process determines (at 2050) whether the predetermined interval has expired. When the predetermined interval has not expired, the process returns to step 2020 where the WiFi access is enabled, the power is unlocked, and the process continues to detect (at 2030) for entry of valid unlock codes. When the predetermined interval has expired and the user has not entered a valid unlock code, the process disables (at 2060) the WiFi access and locks the power supply. The process then ends or returns to step 2030 to detect entry of a valid unlock code. In some embodiments, the process 2000 ends when the power station is returned to the docking station.

In some embodiments, the WiFi access is protected using Wireless Equivalent Privacy (WEP), Wi-Fi Protected Access (WPA), or other forms of password protection and encryption. In this manner, only the user device that was used to unlock the power station is provided access to the WiFi service. The password to gain WiFi access through the power station is entered through a webpage on a browser or through a mobile application that runs on the user device. The user obtains the WiFi password through the same or similar process by which the user obtains the unlock code for the power station. In some embodiments, the password is provided in the message that includes the unlock code. In some embodiments, the password is the unlock code.

It should be apparent to one of ordinary skill in the art that the processor of the power station can independently (i) lock or unlock power from the power supply and (ii) disenable or enable WiFi access. In some embodiments, users are charged a first fee to unlock power for a specified duration and a second fee to enable WiFi access for a specified duration. In some other embodiments, the WiFi access and power are provided free of charge and the processor (i) locks the power supply and enables WiFi access or (ii) unlocks the power supply and disables WiFi access in order to minimize the power drain on the power supply of the power station. In some embodiments, the WiFi access is always enabled.

In some embodiments, the WiFi chipset of the power station further provides network connectivity to the power station. Specifically, administrates can remotely login to the power station in order to configure the power station, monitor power station performance (e.g., check cycle life of the power supply), perform updates to the power station, or perform other management tasks that are specific to the power station. In some such embodiments, the power station includes a network stack and firmware that operate in conjunction with the power station processor to implement a remote management interface. Specifically, the network stack facilitates the remote interface to the power station using existing networking protocols (e.g., Internet Protocol (IP) and Transmission Control Protocol (TCP)). The firmware stores the instructions that store status information about the power station and that provide the instructions for execution by the processor in order to control various functionality of the power station. In this manner, the power stations can be remotely managed without an administrator being physically present at each distributed location of the power stations. Administrators may include administrators of the power distribution system, power station operators, or employees of the establishment that hosts the power station.

C. Embedded GSM/CDMA/3G/4G Extender

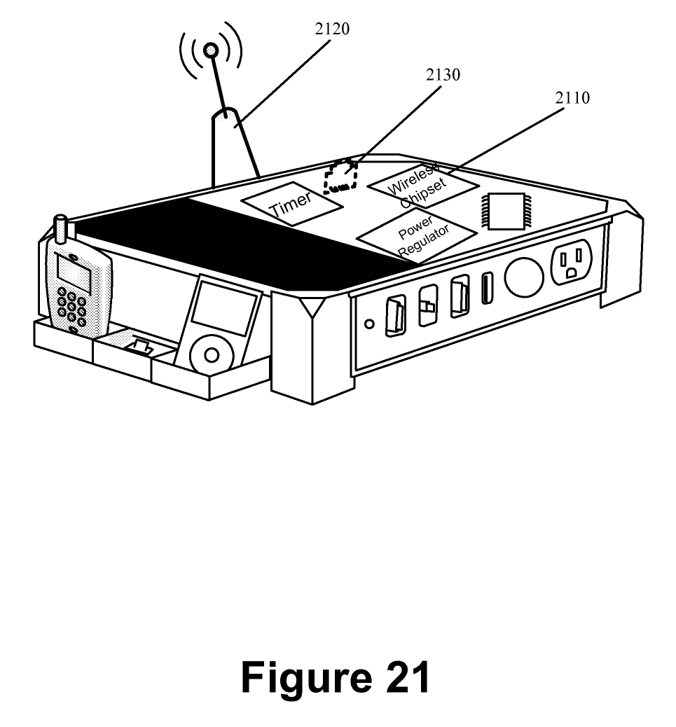

FIG. 21 illustrates the power station of some embodiments enhanced with an embedded Global System for Mobile Communications (GSM), Code Division Multiple Access (CDMA), 3G, and/or 4G extender. Such functionality is implemented by embedding wireless chipset 2110 and by including the antenna 2120 with the power station. The wireless chipset 2110 may include microcell or femtocell chipsets that provide Home Node-B (or home base station) functionality for extending GSM, CDMA, 3G, and 4G (e.g., WiMAX or Long Term Evolution (LTE)) services into the home, establishment, or other areas where there is no wireless coverage or there is insufficient signal strength. In this figure, the antenna 2120 is displayed as an external antenna. However, the antenna 2120 may be an internal antenna in some embodiments.

The wireless chipset 2110 in conjunction with the antenna 2120 act like a mini-cellular tower that provides connectivity to a wireless service provider (e.g., Verizon, AT&T, etc.). The wireless chipset 2110 creates a low power cellular signal (e.g., CDMA, GSM, 3G, or 4G) through the antenna 2120 that spans several meters. This is in contrast to a cellular tower that creates a cellular signal that spans several hundred or thousand meters. Specifically, the low power cellular signal is on the order of some milliwatts whereas the cellular signal from a cellular tower is on the order of several watts.

The user device connects to the signal from the power station as it would to any cellular tower (using existing registration and handover procedures). Communications and data from the user device pass through the power station before passing to the wireless service provider and communications and data from the wireless service provider pass through the power station before passing to the user device. The power station facilitates the transfer of communications and data through the broadband interface 2130 or some other wired high-speed connection. In some embodiments, the broadband interface 2130 is a wired broadband connection (e.g., Ethernet). In some embodiments, the broadband interface 2130 is a wireless broadband connection (e.g., WiFi). The broadband connection is provided by the establishment that hosts the power station. The wireless chipset 2110 transmits wireless signals received from the user device through the broadband interface 2130 and transmits communications or data that are received over the broadband interface 2130 into wireless signals that can be detected by the user device. Various Home Node B functionality for the wireless chipset 2110 of some embodiments is described in further detail in the 3GPP Technical Report 23.832

With the embedded wireless extension functionality, the power station is able to recharge the user device while also providing a high quality signal for voice and data communications where such a signal may not otherwise exist. In this manner, the user device can have wireless connectivity regardless of the size of a building or the number of walls that would normally interfere with or block the cellular signal.

As before, to access power from the power station or to enable the GSM, CDMA, 3G, and/or 4G functionality, the user provides an unlock code using the keypad of the power station. Once a valid unlock code is entered, the processor enables the wireless chipset 2110 thereby enabling the GSM, CDMA, 3G, and/or 4G functionality. Using existing security mechanisms (e.g., registration, encryption, etc.), access to the GSM, CDMA, 3G, and/or 4G functionality may be limited to the user device that was used to obtain the unlock code for unlocking the power station. In some embodiments, the wireless extension functionality is enabled for a predetermined duration when the power station is removed from the docking station.

In some embodiments, the wireless chipset 2110 provides administrators remote access to the power station. As described above, through the remote access, administrators can manage the power station, upload content to the power station, or modify operation of the power station without having physical access to the power station.

D. Display

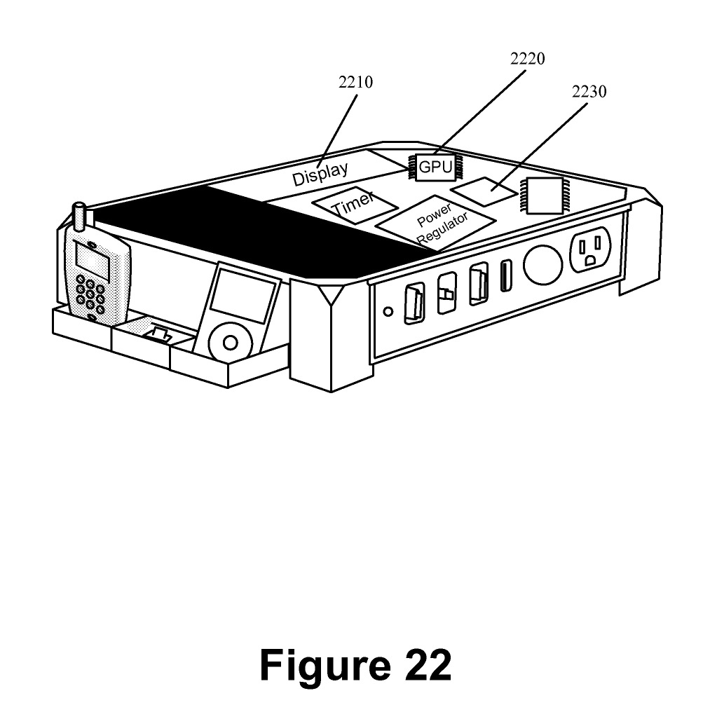

FIG. 22 illustrates the power station of some embodiments enhanced with a display 2210. The display 2210 includes an organic light emitting diode (OLED), active-matrix (AMOLED), or other low power display technology. The display 2210 provides instructions, greetings, advertisements, marketing promotions, or other messages to the user when the user uses the power station. In some embodiments, the power station is also integrated with a speaker to provide auditory content in conjunction with the visual content that is displayed using the display 2210. In some embodiments, the display 2210 is 1.5×1.5 inches though it may be larger or smaller in some other embodiments.

To present content through the display 2210, the power station of FIG. 22 also includes a low power graphics processor 2220 and memory 2230. The graphics processor 2220 provides image decoding (e.g., jpeg, gif, etc.) and video decoding (e.g., mpeg, avi, mov, etc.). The memory 2230 includes CMOS memory or other non-volatile computer readable storage memory. The memory 2230 stores the various images or videos that are displayed on the display 2210. For example, an instructional video may be displayed to inform the user on the features of the power station and on how to unlock these features. Another video may be displayed once the power station is unlocked to provide advertising or marketing promotions.

In some embodiments, the image and video content in the memory 2230 is updated through the WiFi or wireless extension functionality described above. In some such embodiments, administrators remotely access the power station through the network management interface and upload content to the memory 2230 of the power station. The image and video content may also be streamed to the power station from the server of the power distribution system or from a third party server (e.g., an establishment server). In some embodiments, the image and video content is updated when the power station is docked on the docking station or through an interface to the memory (e.g., USB). Through the docking station or interface, administrators can upload or update the content that is displayed on the display 2210 while also performing management operations over the power station.

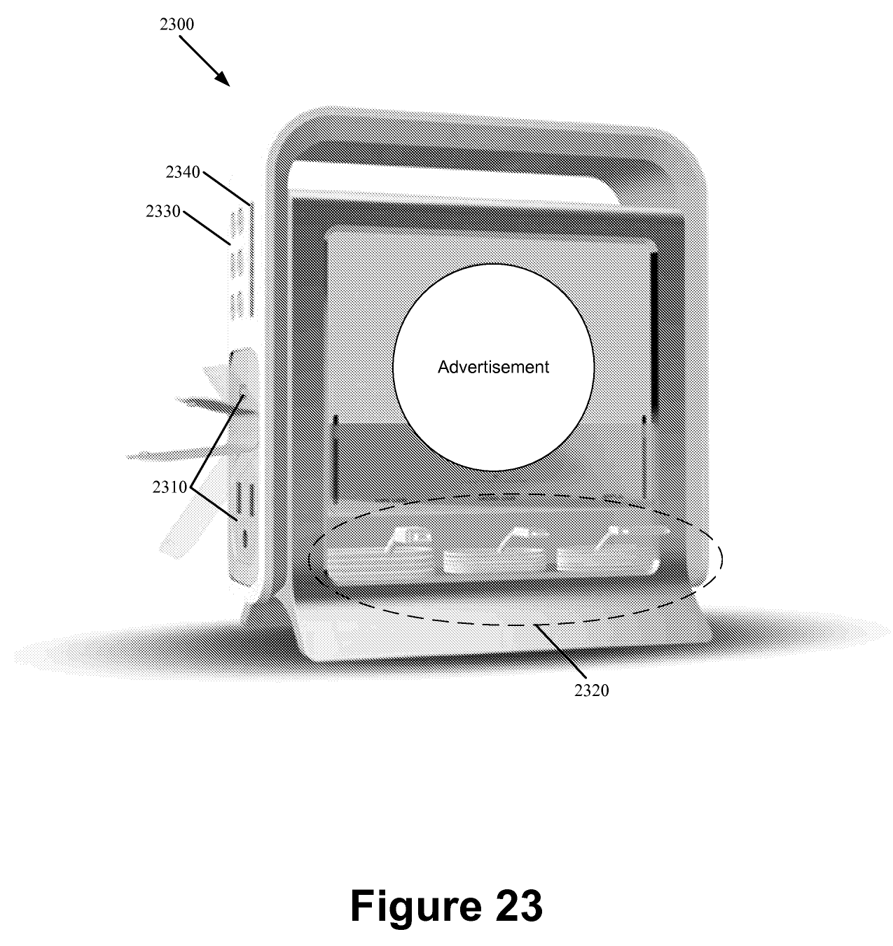

It should be apparent to one of ordinary skill in the art that the look of the power station may be different in some embodiments without affecting the functionality or operation of the power station. For example, FIG. 23 illustrates a power station 2300 of some embodiments. As shown, the power station 2300 includes charging interfaces 2310 that include a standard three prong outlet and a USB port. The power station 2300 also includes charging interfaces 2320 that have retractable cables for USB or Apple based connections. The power station 2300 further includes keypad 2330 and status indicator 2340. The power station 2300 may be modified to include the magnetic stripe reader, WiFi extender, microcell functionality, or display.

V. Power Distribution System Enhancements

In some embodiments, the power distribution system can be leveraged to provide establishments with an ongoing presence on the user device. Specifically, some embodiments provide a mobile application that is downloaded to and run on the user device. The mobile application can be used to access power from a power station of the power distribution system by obtaining the unlock code for the power station. Additionally, the mobile application can be used to connect users to various establishments and to connect the various establishments with the users.

The mobile application connects the users to the various establishments by providing the users access to information and services of the establishment directly from the user device. The mobile application connects the various establishments to the users by providing the establishments with a direct wireless platform to the users. Through this platform, the establishments can provide advertising, promotions, and other information to keep the users interested in the goods and services of the establishments. In some embodiments, the advertising, promotions, and other information may be customized per user based on previous user information or activity. The content may also be customized on-the-fly or in real-time based on user information or activity that is logged by the mobile application as the user uses the mobile application. Accordingly, the mobile application can also be used as platform from which establishments monitor user behavior and acquire data as to the preferences and habits of each user. Based on the data acquired from the mobile application, establishments can provide content that is relevant or more interesting to each user. Furthermore, the acquired data can be used to customize the user experience at the establishment. For example, the experience can be customized for a hotel client that requests extra pillows during a first visit such that during a second visit to the hotel, the hotel automatically provides the extra pillows without the user having to request them.

In some embodiments, power from a power station is provided free of charge when a user device is connected to the power station and the user device is running the mobile application. Additionally, the user device can receive free power when the user device downloads and installs the mobile application. In some embodiments, the user uses the mobile application to obtain an unlock code through some of the above described processes (see FIGS. 2 and 3 described above, the process 900 of FIG. 9, or the process 1000 of FIG. 10 as some examples). In obtaining the unlock code, the mobile application performs a login or registration procedure that identifies the user and a user location to a server of the power distribution system. In some embodiments, the user location is determined from the unique identifier of the power station. In some other embodiments, the user location is determined from location based services of the user device or network triangulation as described below. Based on this information, the mobile application is used as a platform through which to provide customized content or services that are relevant to the user.

The free power from the power stations to charge the batteries of the user devices or the access to the other enhanced power station functionality (e.g., extended WiFi or wireless coverage) provides the incentive and reason for the users to download and run the mobile application. The wireless platform provided by the mobile application with which establishments can target users with relevant content or services provides the incentive and reason for the establishments to host the power stations and provide free power or other enhanced power station functionality to the users that visit the establishments.

Accordingly, the mobile application in conjunction with the power stations of the power distribution system provide several advantages to both users and establishments. Specifically, establishments can build a personal relationship with each of their clients. Through the mobile application, the establishments can provide on-demand and real-time information to the clients. The establishments can express client appreciation using specials, promotions, and targeted advertising in order to generate repeat business or generate interest in new or existing services. The establishments can monitor user activity through the mobile application in order to identify user preferences and provide customized content that is relevant on a per user basis. For example, when a user uses the mobile application to make reservations at a particular restaurant, the establishment server can identify the type of food served by the restaurant and provide the mobile application with suggestions to other restaurants or provide coupons for a subsequent visit to the restaurant.

Through the mobile application, users are provided a convenient means to access services of the establishment. Users can on-demand and in real-time wireles sly request services through the mobile application without having to wait in line to speak to a concierge or an establishment representative. For example, through the mobile application, users can make dinner reservations, order a poolside drink, check into or out of a room, purchase tickets and reserve seating for a show, or book a tour without waiting to speak to a concierge or a booking agent.

In some embodiments, the mobile application is provided by the establishment. In some such embodiments, a different mobile application is downloaded to the user device when the user device is connected to a power station that is located at a different establishment.

In some embodiments, the mobile application is provided by the power distribution system. In some such embodiments, the user device installs one instance of the mobile application. The content for the mobile application may be provided by different servers (e.g., Point of Sale (POS) servers, Customer Relationship Management (CRM) servers, frontend or backend servers, etc.) of different establishments or by one or more servers or databases of the power distribution system.

Content is passed to and received from the mobile application using standardized interfaces and messaging. HyperText Markup Language (HTML), Extensible Markup Language (XML), or Flash based content may be used to populate the display of the mobile application. In some embodiments, the content is passed using IP, TCP, and/or HTTP protocols.

The servers of the various establishments may include standardized interfaces from which the mobile application can directly obtain content from or pass content to the various servers. For example, various servers of different hotels may be standardized per the specifications of the Hotel Technology Next Generation (HTNG) consortium. Therefore, when communicating with a POS server or CRM server of any such hotel, the mobile application utilizes the HTNG interfaces and messaging in order to request data from and provide data to the servers. In some embodiments, Service Modeling Language (SML) messaging is used for communications between the mobile application and servers of various hotel establishments.

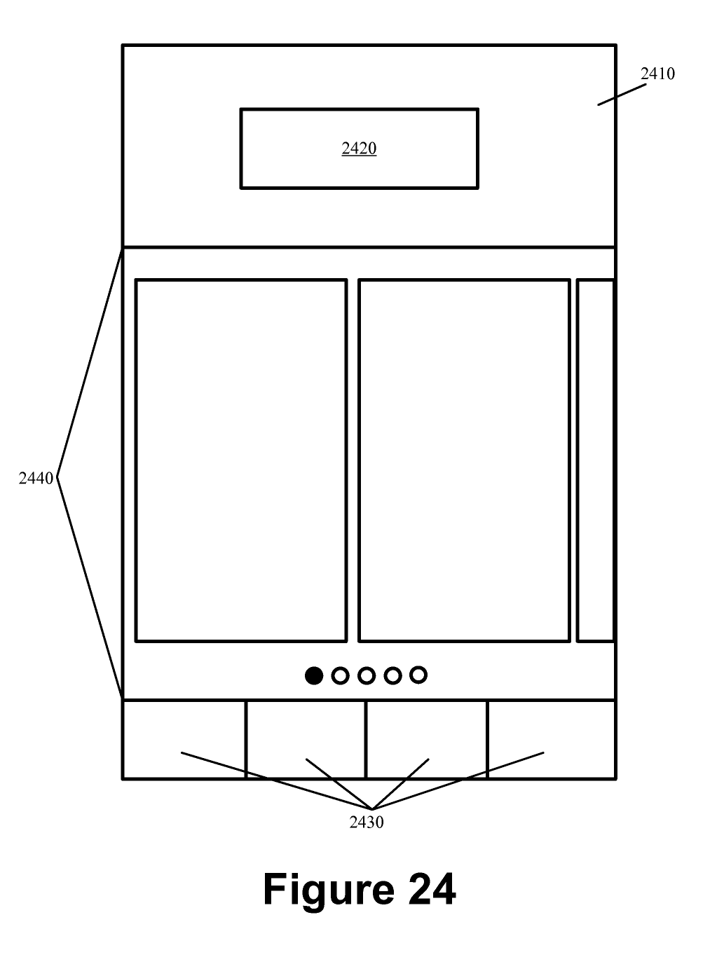

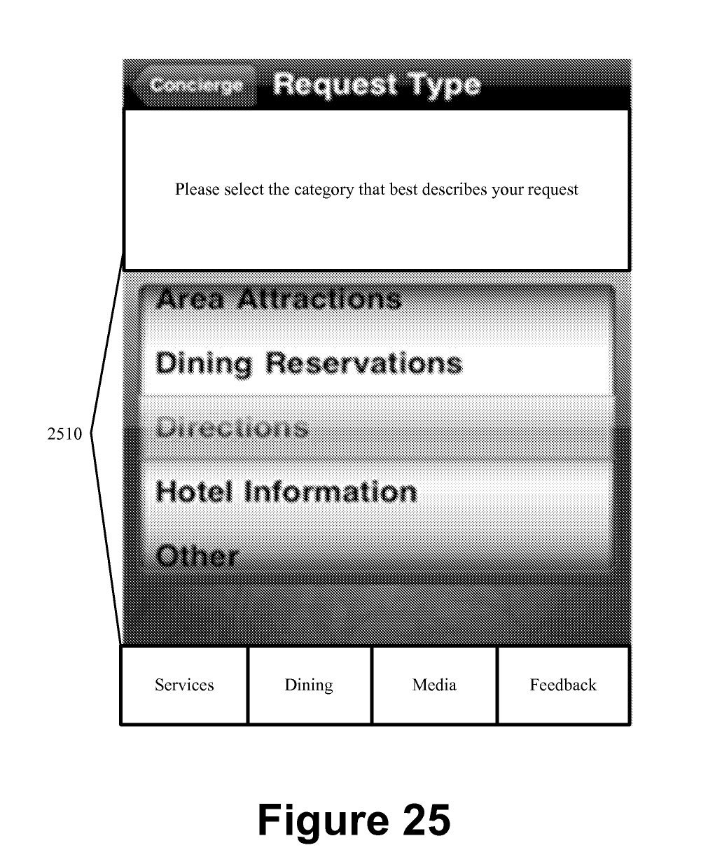

In some embodiments, the mobile application includes various templates that may be customized with content from different servers or content providers. FIG. 24 illustrates a home template for the mobile application. The home template provides the home screen or initial content for an establishment when the mobile application is running. The template includes a custom background 2410, custom logo 2420, primary navigation items 2430, and secondary navigation items 2440. Each of the fields 2410, 2420, 2430, and 2440 can be customized on an establishment to establishment basis or on a user to user basis. The background 2410 and logo 1920 identify the establishment, brand, partners, etc. The primary navigation items 2430 remain onscreen even as the content within the application changes. The primary navigation items 2430 and the secondary navigation items 2440 may change as the content changes. The navigation items 2430 and 2440 include buttons, links, lists, graphics, animations, or icons that may be interacted with using touchscreen inputs or other inputs (e.g., keypad). The content may include HTML pages used as part of the establishment website or content that is specific for the mobile application. For example FIG. 25 illustrates a combo wheel selectable item 2510 that is specific to the mobile application and that provides access to different services of a particular establishment.

To obtain the content for the home template and for subsequent pages, the mobile application initially registers with a server of the power distribution system. Based on registration information (e.g., user identification information and location information), the server connects the mobile application to a particular server of the establishment at which the user is located. A query for home page content is made by either the mobile application or the power distribution system server. For example, the query may be made using a SML or XML formatted message that is passed using the TCP protocol. In response, the mobile application is provided the home page content that is then decoded and displayed within the mobile application.

In some embodiments, the mobile application provides a larger onscreen presence for an establishment when the user is at the establishment and a smaller presence when the user is away from the establishment. In this manner, the mobile application can be used to provide establishments with an active presence and a passive presence. Through the active presence, the content of the mobile application is customized for the establishment at which the user is located. The establishment can provide services to the user, provide marketing or advertisements to the user, and track user behavior and/or user preferences. Through the passive presence, the establishment can send periodic marketing offers or advertising to the user device to keep the user interested in the goods and services of the establishment while the user is away from the establishment.

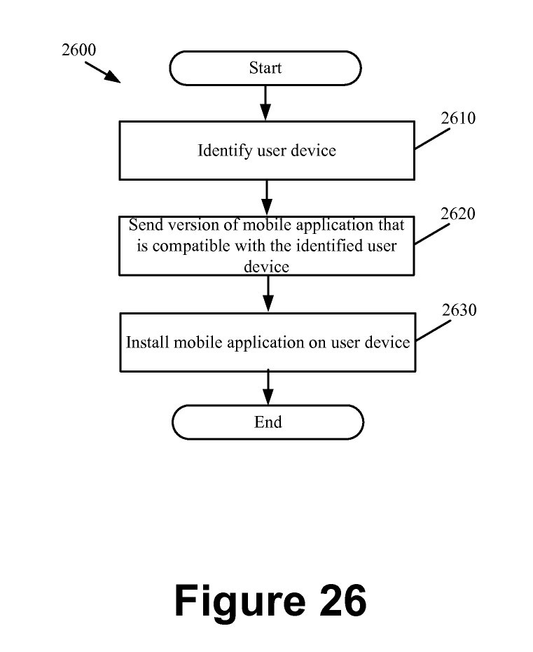

FIG. 26 presents a process 2600 for acquiring the mobile application of the power distribution system in accordance with some embodiments. The process 2600 begins when the user device contacts the server of the power distribution system. The user device may contact the server in order to unlock power from a particular power station. The user device may contact the server through a website (see FIGS. 3 and 4 as an example) or by executing a script when connecting to a power station. The script may be transmitted to the user device through a charging interface that also functions as a data interface to the user device when the user device is connected to the power station through such an interface. The script may also be transmitted wirelessly (i.e., WiFi) to the user device from the power station.

The process identifies (at 2610) the user device. The identification may include identifying a make and model of the user device or an operating system of the user device such as the Android operating system (OS), iPhone iOS, BlackBerry OS, or Microsoft® Windows 7 OS as some examples. In some embodiments, the device is identified through HTML tags when the user device browser contacts the server. In some other embodiments, the script executes on the user device in order to identify the user device.

Based on the identified device, the process sends (at 2620) a version of the mobile application that is compatible with the identified user device. The mobile application is installed (at 2630) on the user device and the process ends. In this manner, the mobile application is automatically provided to the user device without the user having to navigate various links or manually perform the operations needed to install an application on the user device.

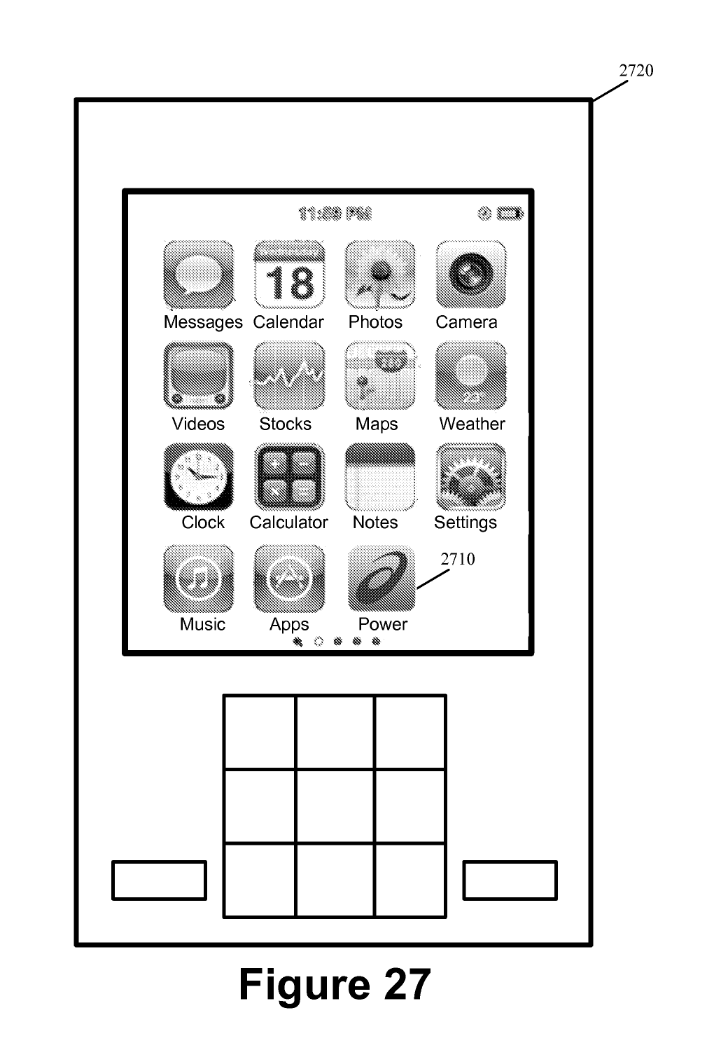

FIG. 27 illustrates an icon 2710 that is generated on the user device 2720 once the mobile application is installed. In this figure, the mobile application resides on the user device 2720 until the user removes or uninstalls the application. When the mobile application is executed by touching or selecting the icon 2710, the mobile application launches and wireles sly connects to the power distribution system server. In some embodiments, the mobile application connects to the power distribution system server through a wireless data connection (e.g., GPRS) of the user device. The mobile application connects to the server to customize the content and services that the mobile application provides based on a location of the user. In some embodiments, the mobile application automatically launches upon detecting a connection to a power station.

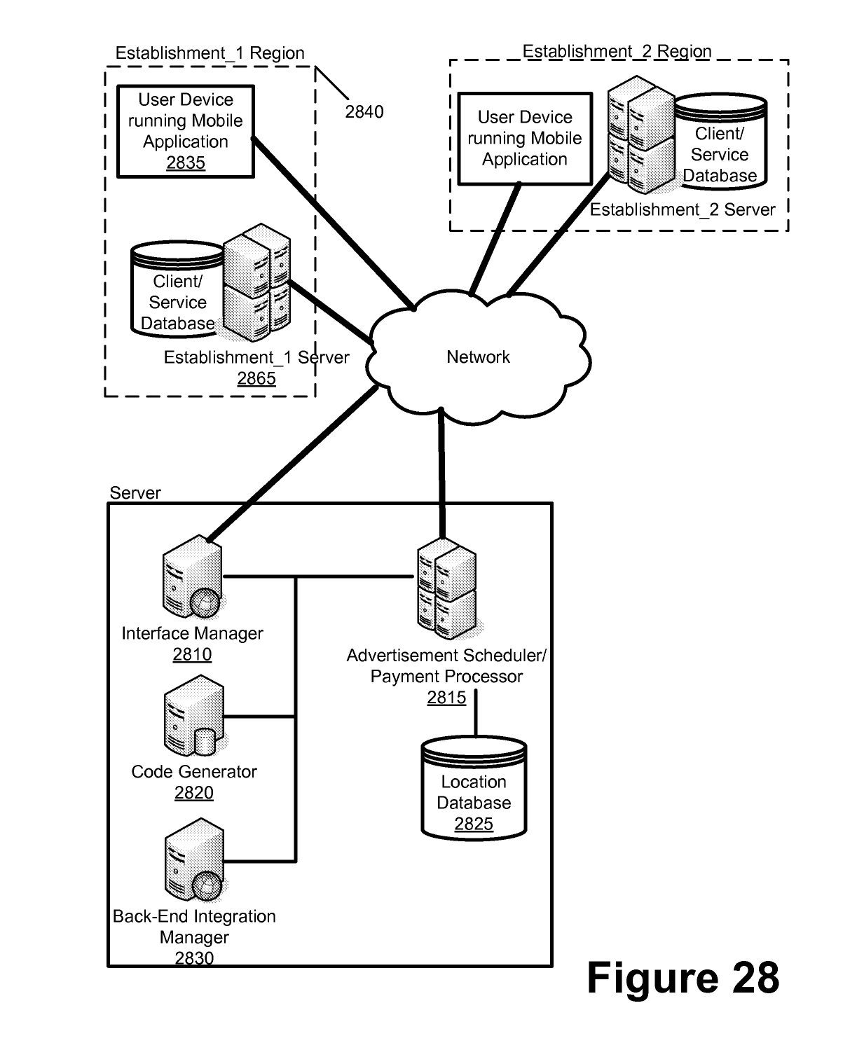

FIG. 28 illustrates an enhanced power system architecture for providing customized content to the mobile application of a user device in accordance with some embodiments. The power system architecture includes the interface manager 2810, advertisement scheduler and payment processor 2815, code generator 2820, and location database 2825 as before. However, the power system architecture is enhanced to include the back-end integration manager 2830. The back-end integration manager 2830 may be implemented on the same or different physical server as the components 2810, 2815, 2820, and 2825. The back-end integration manager 2830 facilitates the distribution of content to the mobile application. The back-end integration manager 2830 facilitates the distribution of the content by either: (1) identifying and passing the content from databases of the power distribution system to the mobile application, (2) connecting the mobile application to a content server of an establishment and facilitating the transfer of content from the server to the mobile application, or (3) connecting the mobile application directly to a content server of an establishment whereby the identification and passing of the content is performed without the back-end integration manager 2830 or other components of the power distribution system acting as an intermediary. In this manner, the back-end integration manager 2830 facilitates which establishment is provided an active presence within the mobile application.

A. Active Presence

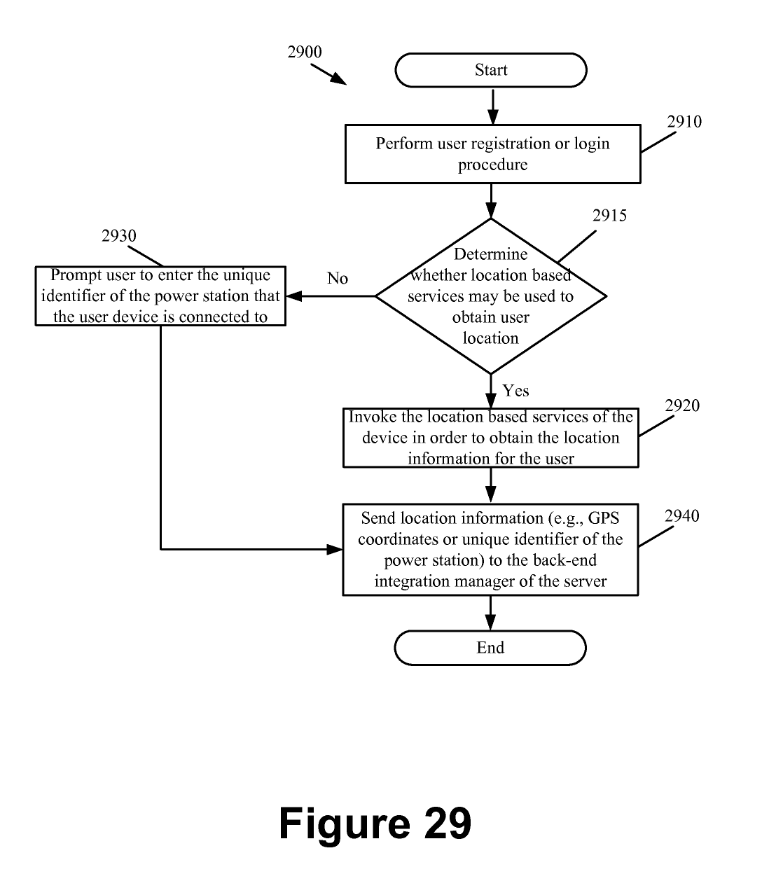

The back-end integration manager 2830 determines which, if any, establishment is provided an active presence on the mobile application of a user device based on location information that is obtained from the user device. FIG. 29 presents a process 2900 performed by the mobile application to obtain location information from the user device in accordance with some embodiments. In some embodiments, the process 2900 is performed when the mobile application is launched on the user device or when the user device is connected to a power station.

The process performs (at 2910) a user registration or login procedure using the mobile application. The registration or login procedure may be performed as described above in order to obtain an unlock code to unlock power from a particular power station. The registration or login procedure may include the steps for FIGS. 2 and 3 described above, the process 900 of FIG. 9, the process 1000 of FIG. 10, or some other process by which the user unlocks power from a particular power station. In some embodiments, the registration or login step is automatically performed when the mobile application is launched. In some such embodiments, the mobile application stores the username and password and automatically sends this information to the power distribution system server when the mobile application is launched.

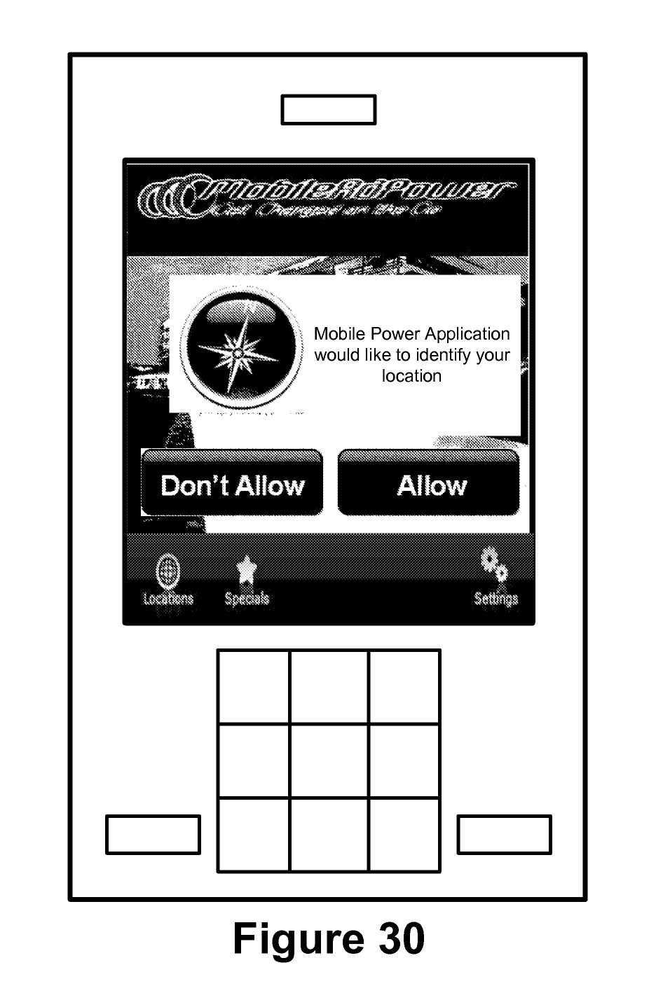

The process determines (at 2915) whether location based services of the user device or network triangulation may be used to obtain the user location. Location based services utilize an embedded Global Positioning Satellite (GPS) receiver of the user device to identify the location of the user device. In some embodiments, the mobile application prompts the user for permission to use the location based services or network triangulation as shown in FIG. 30.

When the user provides the permission, the mobile application invokes (at 2920) the location based services of the device via a set of commands, instructions, or scripts of the mobile application. Alternatively, the mobile application can utilize a set of commands, instructions, or scripts to triangulate the user's location based on available network information. From the location based services of the user device or network triangulation, the mobile application obtains the location information for the user device. The location information includes GPS coordinates (e.g., longitudinal and latitudinal coordinates).

The user may disallow the use of the location based services or the location based services may be unavailable because the user device does not support the location based services or signal strength is not sufficiently strong to obtain the location information. Similarly, the use of network triangulation may be disallowed or unavailable. In such cases, the process prompts (at 2930) the user to enter the unique identifier of the power station that the user device is connected to or wishes to connect to. In some embodiments, the user enters a multiple digit code using the keypad of the user device. In some other embodiments, the user uses a camera of the user device to take an image of a bar code or symbol on the power station that can be decoded by the mobile application to obtain the unique identifier. As noted above, the unique identifier is registered with a particular location or establishment and the server can identify the user device location based on the unique identifier of the power station.

In either case, the process sends (at 2940) the location information (e.g., GPS coordinates or unique identifier of the power station) to the back-end integration manager 2830 and the process ends. Based on the received location information, the back-end integration manager 2830 identifies and connects the mobile application of the user device to the appropriate establishment server that is associated with the user device location. For example in FIG. 28, user device 2835 is located in the region of the first establishment 2840. Therefore, based on the location information that is provided by the user device 2835, the back-end integration manager 2830 connects the mobile application running on the user device 2835 to the server of the first establishment 2865. The region of each particular establishment includes the property, grounds, or surrounding area of a particular establishment. The establishment may include a hotel, resort, spa, restaurant, coffee shop, etc.

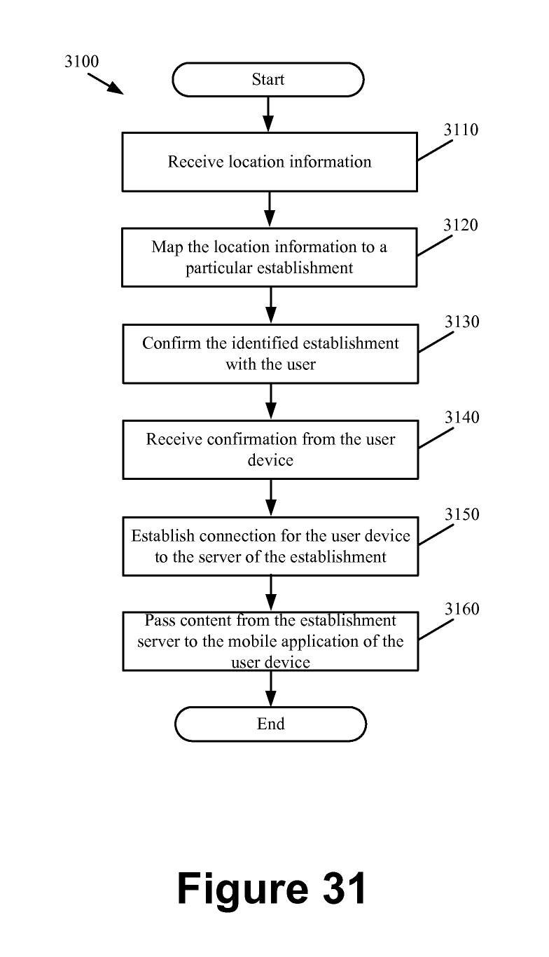

FIG. 31 presents a process 3100 performed by the back-end integration manager to connect the mobile application of a particular user device to the appropriate establishment server in accordance with some embodiments. The process 3100 begins whenever the mobile application of a particular user device sends location information to the power distribution system server or, more specifically, to the back-end integration manager of the server.

The process receives (at 3110) the location information. The process maps (at 3120) the location information to a particular establishment. When GPS coordinates are provided, the process passes the coordinates to the location database 2825 of the server in order to identify a particular establishment associated with the coordinates. For example a particular hotel is defined to a range of GPS coordinates and when the GPS coordinates provided by the user device fall within the range of coordinates defined for a particular hotel, the process identifies the particular hotel as the particular establishment at which the user device is located. When the unique identifier of the power station is provided, the process performs a lookup in the location database 2825 to identify which establishment the power station is registered with in order to determine the location of the user device.

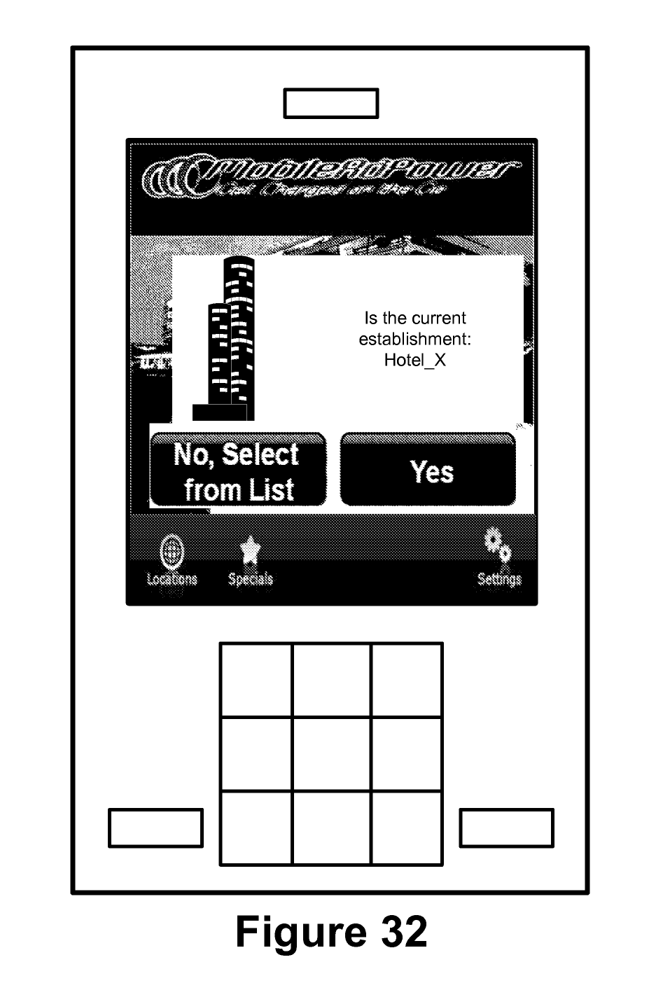

The process optionally confirms (at 3130) the identified establishment with the user. To do so, the back-end integration manager sends the identified establishment along with a set of nearby establishments to the mobile application of the user device. In some embodiments, the mobile application receives the information and provides the prompt of FIG. 32 to confirm that the user device is at the identified establishment or some other establishment. The process receives (at 3140) confirmation from the user device once the user interacts with the mobile application to select the correct establishment.

Next, the process establishes (at 3150) a connection for the mobile application running on the user device to the server of the establishment. In some embodiments, the connection is an IP based connection and may include a TCP session. To establish the connection, the process passes identification information that is used to facilitate communication with the mobile application. In some embodiments, this information includes an IP address and/or TCP port of the user device or mobile application. The process establishes a connection between a server of the establishment and the mobile application. The server of the establishment may include one or more of a Point of Sale (POS) server for e-commerce transactions, a frontend or backend server for user services, and a CRM server for storing user preferences or previous user activity. It should be apparent that other servers may also be included. In some embodiments, when the process establishes the connection, the process also sends identification information for the user (e.g. username and password) to the establishment so that the establishment can customize the content it sends to the user. Such communication is performed using standardized interfaces and messaging between the mobile application, power distribution system server, and servers of the various establishments.

From the established connection, the back-end integration manager 2830 passes (at 3160) content from the establishment server to the mobile application that is running on the user device. The content may be passed using SML based messaging or other messaging formats (e.g., XML). In some embodiments, the process or back-end integration manager 2830 maintains the connection while the mobile application runs on the user device. In some embodiments, the back-end integration manager 2830 or one or more databases of the power distribution system host the content for the establishment and the back-end integration manager 2830 directly passes the content to the mobile application on the user device. In some embodiments, the back-end integration manager 2830 acts as an intermediary between the mobile application and the establishment server whereby all messages are passed through the back-end integration manager 2830. In some embodiments, the back-end integration manager 2830 establishes the connection directly between the mobile application and the establishment server so that the back-end integration manager 2830 is no longer an intermediary.

i. Mobile Application Marketing

In some embodiments, the mobile application provides establishments a platform through which to stay connected with their clients while the users are at the establishment. In some embodiments, the content passed to the mobile application may include information about the establishment at which the user device is located. Such information can promote the establishment and generate user interest in the establishment brand by informing users of the advantages and distinguishing characteristics of the establishment over its competitors. The information can also generate interest in goods and services that the user was previously unaware of.

In some embodiments, the content that is passed to the mobile application includes targeted advertisements or promotions for goods and services of the establishment or partners of the establishment. For example when the establishment is a hotel, the hotel server passes content to the user device that includes special room rates, spa services, restaurant specials, and other such coupons. Such advertising and promotions enable the establishment to retain users on the property premises while promoting the establishment, its business partners (e.g., retailers, service providers, etc.), and its overall brand. Other advertising or marketing may include promoting the hotel brand by notifying the user of other hotel locations or partners. For example, the hotel may have a partnership with a car rental corporation or tour provider.

The informational content, advertisements, or promotions may include graphics, text, audio, and video. In some embodiments, the information, advertisements, or promotions are presented using a mobile spokesperson. The mobile spokesperson is a representation of a person that is presented on the display of the user device. The mobile spokesperson can be used to convey advertising or promotional messages as well as other informational messages (e.g., instructional messages) to the user. The mobile spokesperson may be embedded within content that is passed to the mobile application such that when certain actions are performed or certain content is displayed, the mobile spokesperson is also presented. The mobile spokesperson may be a recorded video or may be an interactive representation that on-the-fly adjusts based on user actions. Using the mobile spokesperson, some embodiments provide a virtual concierge or representative that is customized for the establishment at which the user is located. Accordingly, the mobile spokesperson can assist users in requesting content, goods, or services as well as answering questions that the user may have.

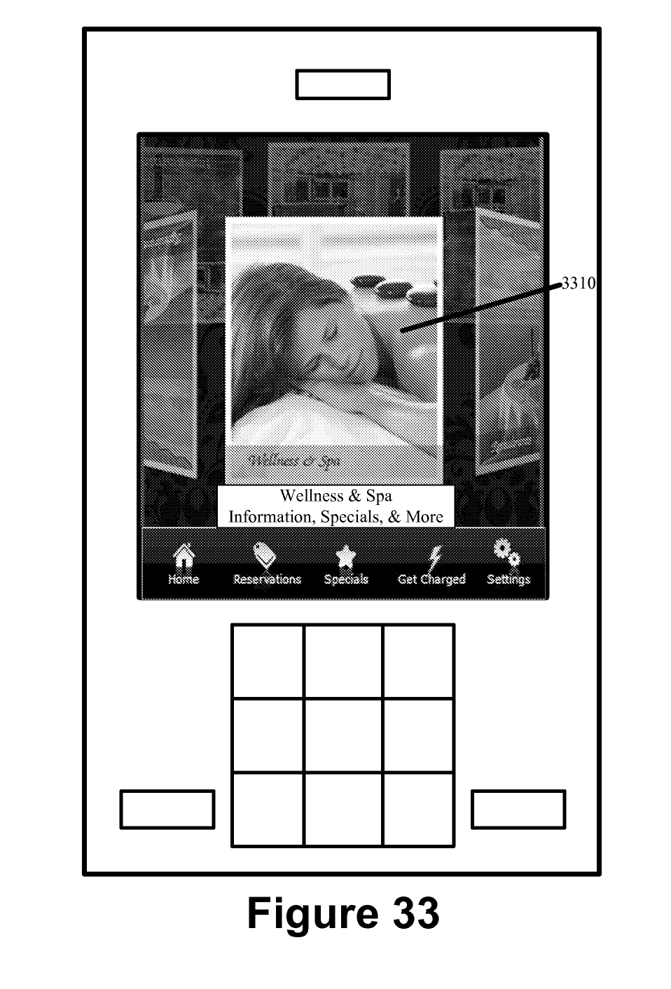

FIG. 33 illustrates the mobile application displaying targeted advertisements and promotions in accordance with some embodiments. As shown, the mobile application displays advertisements and promotions 3310 that the user can navigate between using touch gestures or other inputs (e.g., keypad). In this figure, the frontmost content relates to a spa promotion that is associated with a particular establishment. Should the user select the promotion, the mobile application may display content related to reserving a spa service or providing information about the spa, its services, its fees, etc. In some embodiments, when the promotion is selected, the mobile application displays a website that is linked to from the promotion.

In some embodiments, the mobile application facilitates e-commerce transactions. Specifically, the user can purchase a good or service by selecting an advertisement or promotion through the mobile application. The mobile application may then prompt the user for payment information (e.g., credit card information). The user can enter the payment information into the mobile application using a keypad or other input means provided by the user device. Alternatively, the user can connect the user device to a power station that is enhanced with the magnetic stripe reader of FIG. 17. The user can then swipe a credit card or other card with payment information through the magnetic stripe reader or wave the card over an RFID terminal of the power station after which the payment information is automatically populated within the mobile application as described with reference to FIG. 18 above. The user verifies the information before causing the mobile application to send the payment information to an e-commerce server using the wireless connectivity of the user device. In some embodiments, the mobile application encrypts the payment information in order to securely pass such information over the network.

The e-commerce server authorizes the transaction and provides confirmation of the completed transaction to the mobile application and/or an establishment server from which the good or service was purchased. In some embodiments, the e-commerce server is part of the establishment server. In some other embodiments, the e-commerce server is the advertising scheduler and payment processing component 2815 of FIG. 28. In still some other embodiments, the e-commerce server is a service provided by a third-party such as the Apple App Store. Billing information for the user may be retrieved based on user registration or login information that was provided by the user when first launching the mobile application or through information that is provided by the user using the mobile application or using the magnetic stripe reader of FIG. 17. The e-commerce transaction may be billed to a credit card or to a hotel room number when the user is staying at a hotel.

To perform targeted advertising or targeted promotions to the end user, the mobile application provides the user with a short questionnaire when the mobile application is first launched or when the mobile application is used to access power from a power station of a different establishment. The questionnaire allows the establishment to gather information about the user that is specific to the establishment. In the hotel example above, the questionnaire may ask the user whether the user is interested in receiving spa promotions, room specials, or what kind of food the user prefers in order to recommend restaurant partners to the user.

In addition to or instead of the questionnaire, the establishment may perform targeted advertising and promotions based on information about the user that is stored on the establishment's servers or the power distribution system server(s). Such information may be obtained when the user checks-in to a hotel, makes a reservation, or obtains any other services from the establishment.

Additionally, information about the user may be obtained in real-time as the user interacts with the mobile application. Accordingly, in some embodiments, the mobile application logs user actions such as user selections, purchases, requests, and clicks as the user interacts with the content that is presented in the mobile application. Additionally, the mobile application can be used to track how much time a particular user spends viewing certain content in order to identify content that the user is interested in. In some embodiments, each monitored user action is sent from the mobile application to an establishment server or the back-end integration manager of the power distribution system whereby the actions are aggregated and analyzed to identify trends or preferences for each particular user. Based on the monitored actions, the content and services provided to the user can be customized.

For example, when the user selects a particular advertisement or promotion to view using the mobile application, the back-end integration manager or the establishment server can identify what the advertisement or promotion is and provides future advertisements and promotions that are similar or relevant to the one that the user selected. Similarly, when the user spends a particular amount of time viewing a particular advertisement or promotions, the back-end integration manager or the establishment server can identify the particular advertisement or promotion that the user is interested in and focus future advertisements or promotions to be similar to the identified advertisement. Moreover, the monitored user actions can be used to customize the user experience at the establishment based on the monitored actions. Accordingly, when the user requests certain services or accommodations through the mobile application, the requests or accommodations can be logged such that the same requests or accommodations can be fulfilled for the next user visit to the establishment without the user having to repeat them.

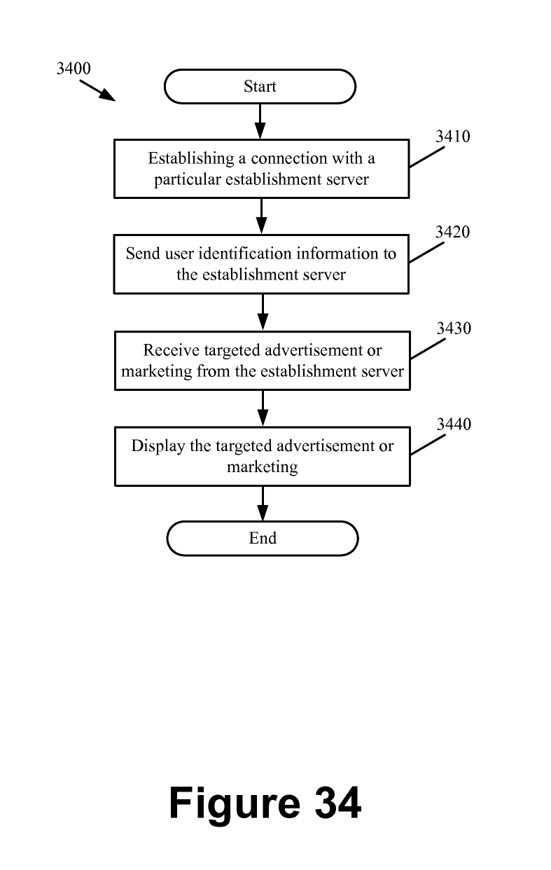

FIG. 34 presents a process 3400 for performing targeted advertising or promotions on the mobile application of a user device based on information that is stored on an establishment server in accordance with some embodiments. The process begins by the mobile application establishing (at 3410) a connection with a particular establishment server through the back-end integration manager of some embodiments. The process sends (at 3420) user identification information to the establishment server. In some embodiments, when the mobile application is launched, the user provides login information (e.g., username and password) that passes to the establishment server through the back-end integration manager. In some other embodiments, when the user connects to the back-end integration server and a connection is established with the establishment server, the content from the establishment server requests identification information from the user. For example, the mobile application requests the user to fill out a questionnaire, specify a hotel room number, or a username and password.

The user identification information is used by the establishment server to identify and/or customize one or more advertisements or marketing promotions to pass back to the user device for display on the mobile application. For example, when a hotel client is identified, the establishment server identifies the length of the user's stay, any upgrades, purchases, or reservations made by the user, and other such information to target advertising or promotions to the user based on such information. The establishment server can utilize any such criteria to determine the customized content to pass to the mobile application. Accordingly, the process receives (at 3430) and displays (at 3440) the targeted advertisement or promotions.

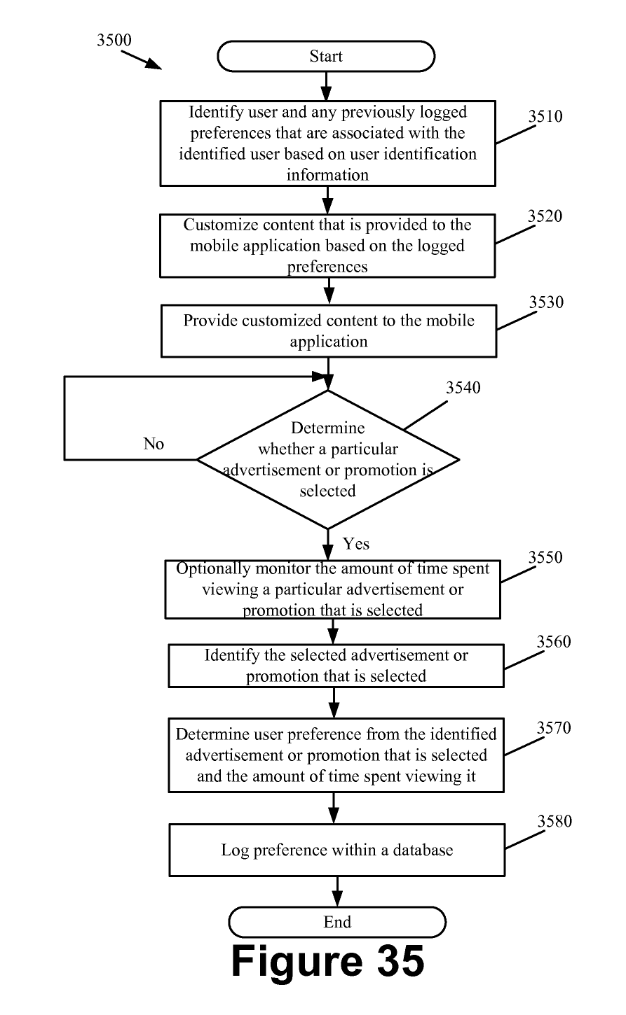

FIG. 35 presents a process 3500 that is performed by the mobile application, back-end integration manager, and/or establishment server to track user activity and customize content that is provided to the mobile application based on the tracked user activity in accordance with some embodiments. The process 3500 begins when the mobile application is launched and user identification information is provided.

Based on the user identification information, the establishment server identifies (at 3510) the user and any previously logged preferences that are associated with the identified user. The process customizes (at 3520) content that is provided to the mobile application based on the logged preferences. Some embodiments utilize a set of algorithms that determine the customized content based on the logged preferences. Specifically, the logged preferences can be used to perform modified queries to a content database whereby the preferences identify different sets of content to send o the user. The customized content is provided (at 3530) to the mobile application of the user. When no prior logged preferences exist, the process may provide a default set of content to the mobile application.

When the content is displayed within the mobile application, the process determines (at 3540) whether a particular advertisement or promotion is selected from the content. When no selection is made, the process continues to monitor user activity by returning to step 3540. When a selection is made, the process may optionally monitor (at 3550) the amount of time the user spends viewing a particular advertisement or promotion that is selected. Next, the process identifies (at 3560) the selected advertisement or promotion. A user preference is determined (at 3570) from the identified advertisement or promotion that is selected and the amount of time the user spends viewing it. The process logs (at 3580) the preference within a database so that it is associated with the user identification information. The process ends or returns to step 3540 for as long as the mobile application is running.

The logged preferences are accessed each time the user provides user identification information or accesses content from the particular establishment. Specifically, the user identification information is obtained and the establishment server customizes the content that is provided to the mobile application based on the logged preferences that are associated with the user identification information. In this manner, when a user selects one or more advertisements or promotions that are related to theatre events, the content can be customized to make the home page display advertisements and promotions that are related to theatre events or the content can be customized so that the advertisements and promotions that are available from within the mobile application are mainly related to theatre events and not other goods or services (e.g., sporting events, spa promotions, etc.).

ii. Mobile Application Services

In some embodiments, the mobile application provides an available wireless platform from which users can request and obtain services from the establishment. Through the connection to the establishment server, the mobile application downloads content that interactively allows a user to access different services of the establishment. In this manner, the user can request or perform specific services without waiting to speak to a concierge or booking agent, identifying himself/herself to the concierge or booking agent, and waiting for the concierge or booking agent to pull up the desired service in order to request the service on behalf of the user. Accordingly, the user can request or perform specific services on-demand, in real-time, and without an intermediary (e.g., concierge, booking agent, etc.).

Examples of some services that can be requested or performed through the mobile application include checking into or out of a hotel room, making reservations (e.g., restaurant, spa, golf tee time, etc.), ordering drinks while at the beach or pool, purchasing tickets to an event, requesting room service, requesting extra towels, and requesting taxi service. It should be apparent to one of ordinary skill in the art that different establishments offer different services and therefore the content of the mobile application is customized on a per establishment basis.

Moreover, the mobile application can provide a real-time view of what services are available at what time. For example, when reserving a golf tee time, the mobile application can in real-time display available times. As another example, the mobile application can identify available seats and times for a particular show that the user wishes to attend.

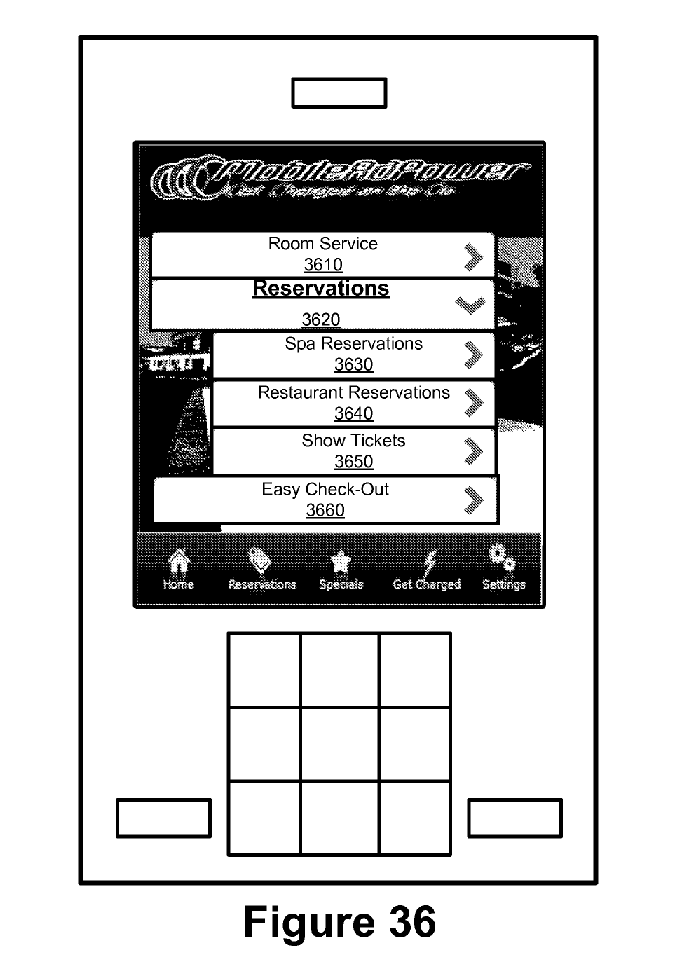

FIG. 36 illustrates some services that are accessible using the mobile application when at a particular establishment in accordance with some embodiments. As shown, the mobile application displays various icons 3610-3660 for different services of the particular establishment that the user can access. Such content is provided when the mobile application is launched while at the particular establishment or while the user device is connected to a power station that is located at the particular establishment.

As an example, the user may be poolside at a hotel or resort. The user device may be running low on power. The user requests and is provided a power station that is brought to the user poolside location. The user uses the mobile application to unlock power from the power station. In so doing, the user is identified to the establishment server that then provides the user with available services through the mobile application. The user can connect the user device to the power station to receive free power or power at a nominal fee. While the device is recharging, the mobile application displays the services of FIG. 36 or other services of the establishment onscreen. For instance, the user can use the mobile application to place an order for a drink without waiting for a waiter/waitress. The drink order is wirelessly transmitted to the establishment server where it is routed to the poolside drink ordering system. The drink is prepared and brought to the user. In some embodiments, the user is identified by the identifier of the power station that the user device is connected to. In some other embodiments, the power station includes a signaling mechanism to grab the attention of the establishment staff member who brings the drink (e.g., a flag). As before, e-commerce transactions are processed by the establishment server or the advertising scheduler and payment processing component of the power distribution server.

In some embodiments, the services that are provided through the mobile application are customized per user based on previously obtained information about the user or user preferences. Such information may be obtained using a short questionnaire that is provided through the mobile application when the mobile application is launched at a particular establishment. The information may be obtained through preexisting information about the user in the establishment server or the power distribution server (e.g., a user that has previously checked into a hotel). Additionally, the information may be obtained by monitoring user activity through the mobile application as described above with reference to FIG. 35. Accordingly, the establishment server can provide the mobile application with services that are relevant to the user's preferences or past activity.

In addition to or instead of customizing the mobile application content, some embodiments utilize the mobile application to customize the user experience at the establishment. As described above, the mobile application can be used as a monitoring tool that tracks user activity at the establishment. Whenever the user makes a purchase, requests a service, or views specific content, the mobile application can monitor such user actions and log the information within the establishment server. The establishment server can then use various algorithms to determine user behavioral patterns or the information can be manually monitored by the establishment staff to determine how to provide a customized experience for a user. For example, the user may place an order for room service and request a meal to be prepared in a specific manner (e.g., no tomatoes). The next time the user places the same order, the establishment server may automatically modify the order as per previous user preferences. As another example, the user may use the mobile application to reserve a room at a hotel that was previously visited. The establishment server can identify any previous requests the user made for the room during the previous visit and have the accommodations made in advance the next time the user arrives (e.g., extra towels, turndown service at 4 pm, etc.).

The mobile application may also be used to recall or confirm previously requested services. In this manner, the user can recall a reservation time, show time, or other such information without calling an establishment representative, identifying himself/herself to the representation, and waiting for the establishment representative to pull up the desired information. The mobile application provides an on-demand wireless platform through which a particular user can access information that is relevant to that particular user.

The active presence on the mobile application therefore provides establishments with a previously unavailable means of continually staying connected with their users. Such functionality is enabled by the portable power stations of the power distribution system. Specifically, the power stations provide the incentive and reason for the users to download the mobile application and the mobile application provides the incentive and reason for the establishment to host the power stations and provide free power to users anywhere on the establishment property. It should be apparent to one of ordinary skill in the art that even when the mobile application is used, the power distribution system may require the user to view one or more advertisements or pay a nominal fee in order to unlock a power station or access services through the mobile application.

B. Passive Presence

In some embodiments, the mobile application provides a passive presence for an establishment when the user is not at the establishment. In some such embodiments, the establishment that the user previously visited can continue to periodically send advertisements or marketing promotions to the user to keep the user engaged with the establishment, its services, and its partners. As noted above, the establishment with an active presence is provided a majority of the mobile application screen. However, establishments with a passive presence can scroll advertisements or marketing promotions at the bottom of the mobile application. Additionally, establishments with a passive presence can push content to the mobile application that the user can selectively view. The mobile application notifies the user of the available content and if the user chooses, he/she can view the content.

In some embodiments, the mobile application pulls content from passive establishments whenever the mobile application is launched or at specified intervals (e.g., once a week). In still some embodiments, establishments can have a passive presence by sending periodic emails to an email account that is registered by the user. The emails may contain advertisements, marketing promotions, service reminders, notifications of new services, or links to access content from a web browser application.

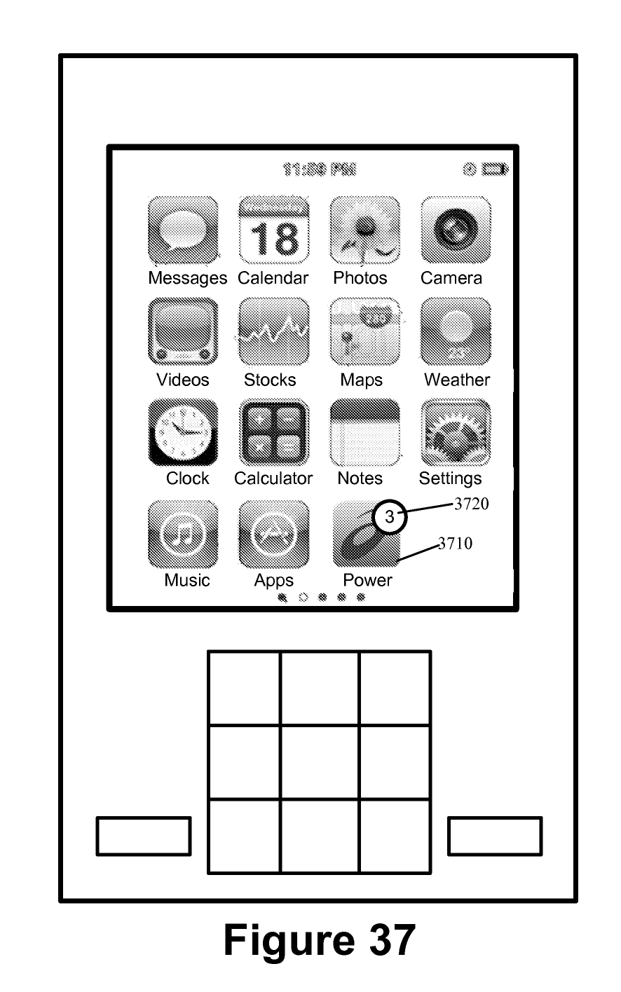

FIG. 37 illustrates content that is pushed to the mobile application of a user from one or more establishments that have a passive presence on the mobile application. As shown, the icon 3710 of the mobile application is overlaid with a badge 3720. The badge 3720 notifies the user of different content from one or more establishments that has been pushed to the mobile application and is available to view.

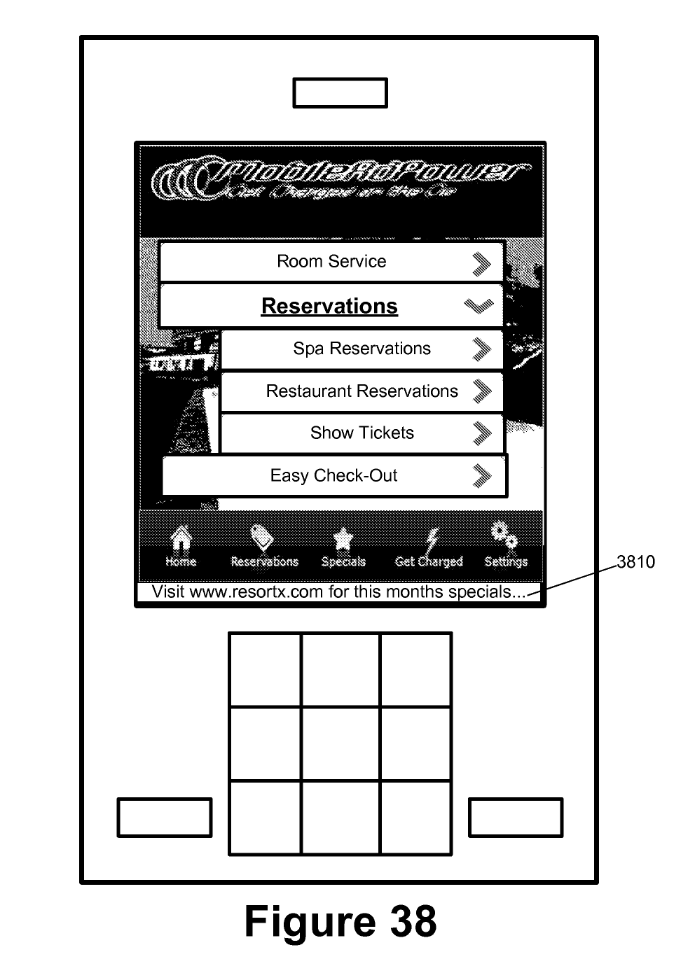

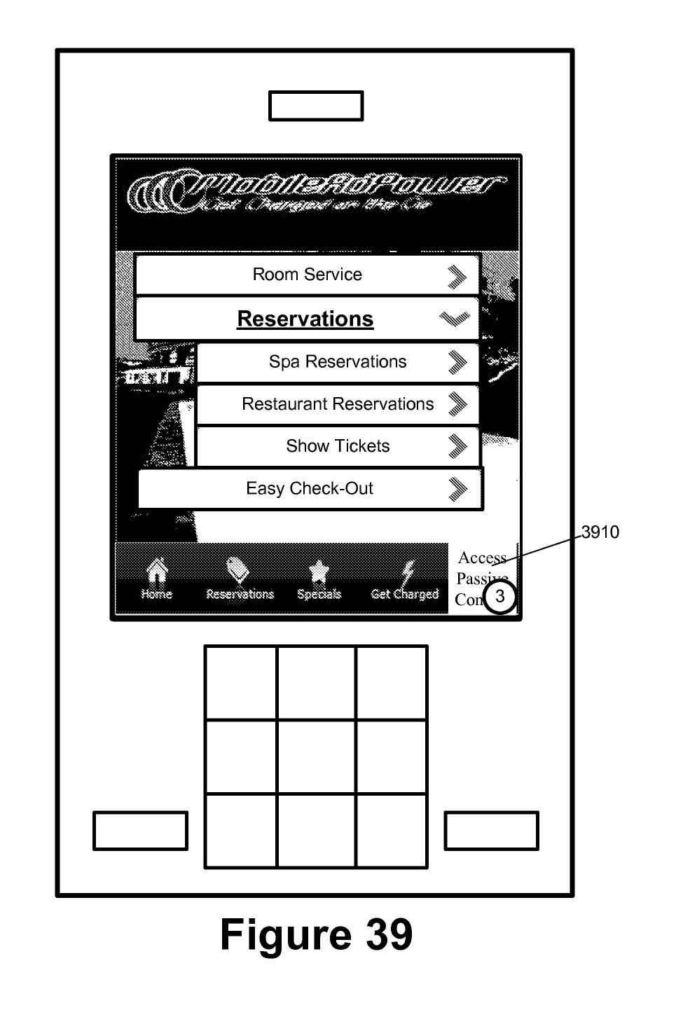

FIGS. 38 and 39 illustrate accessing pushed content using the mobile application. In FIG. 38, the mobile application is running, a particular establishment is provided an active presence, and one or more other establishments are provided a passive presence by scrolling advertisements, marketing promotions, or other messages at the bottom of the mobile application 3810.

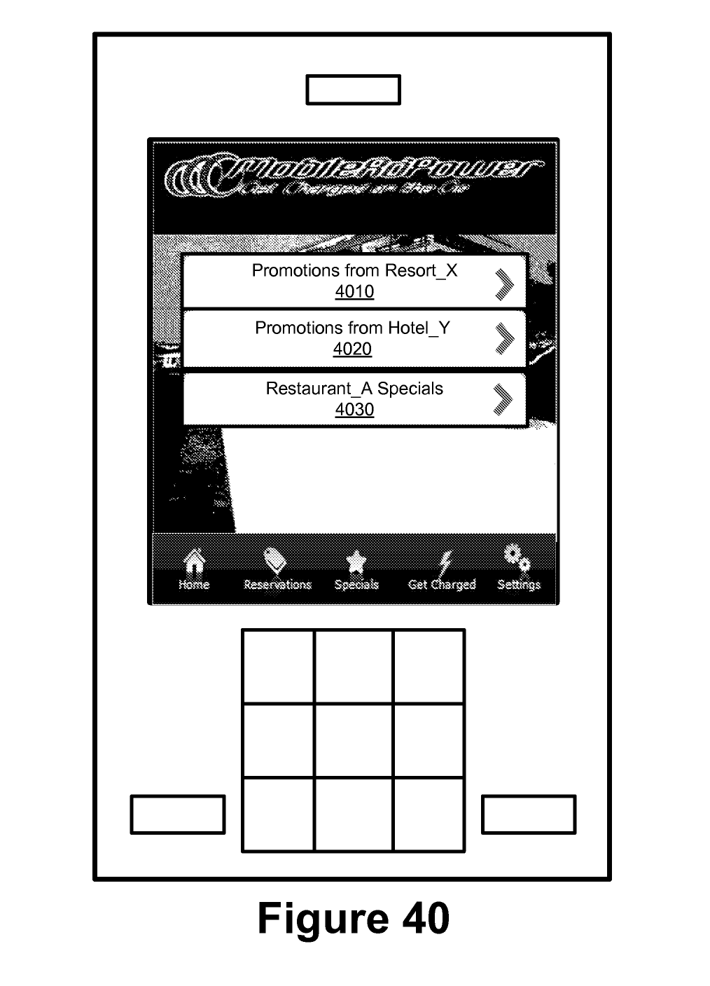

In FIG. 39, the mobile application is running and the user selects an icon 3910 at the bottom to access pushed content from establishments with a passive presence. FIG. 40 illustrates the mobile application display when the icon 3910 is selected in accordance with some embodiments. As shown, the mobile application displays various icons 4010-4030 for different advertisements, marketing promotions, or other messages provided by different establishments that do not have an active presence (i.e., the user device is not located on the establishment property). When an icon 4010, 4020, or 4030 is selected using a touch input or keypad input, the mobile application display changes to show the advertisement, marketing promotion, or other messages that are associated with the selected icon. In some embodiments, the content of the advertisement, marketing promotion, or other messages are downloaded from the corresponding establishment server when the icon is selected. In some other embodiments, the content of the advertisement, marketing promotion, or other messages are already pushed and stored on the user device. In some embodiments, when the icon 3910 of FIG. 39 is pressed, the mobile application opens an email application or link to an email website of the user from which the user can access the advertisements, marketing promotions, or other messages.

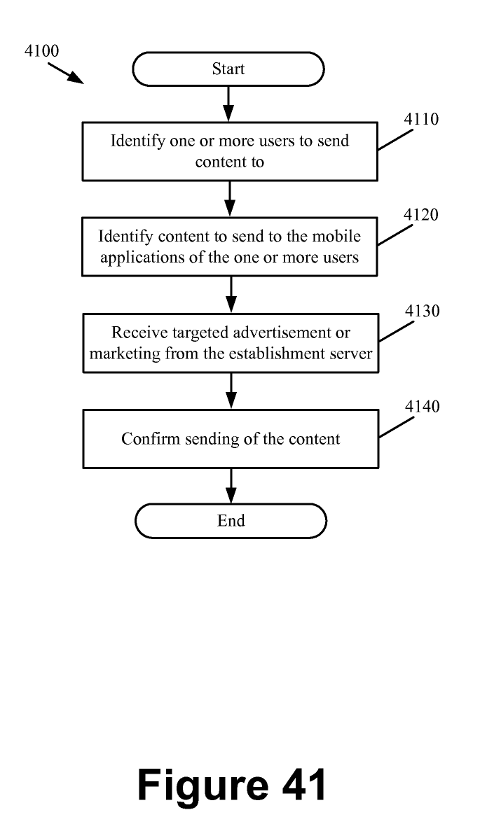

FIG. 41 presents a process 4100 for pushing content from an establishment that has a passive presence to the mobile application on a particular user device. The process 4100 begins by the establishment server identifying (at 4110) one or more users to send content to. In some embodiments, the users previously accessed power from a power station at the establishment or used other services through the mobile application of some embodiments.

The process identifies (at 4120) content to send to the mobile applications of the one or more users. In some embodiments, the content is customized based on previous user activity or behavior. The process pushes (at 4130) the identified content to the mobile application. In some embodiments, the content is pushed using wireless data networks. Specifically, the establishment server may store the IP address, Subscriber Identity Module (SIM) identifier, or other identification information of the user device in order to push the content to the user device. In some other embodiments, the identification information is stored by the back-end integration manager of some embodiments. Instead of passing the full content, the process may pass icons or links to allow the user to access the content when desired. Optionally, the process confirms (at 4140) the sending of the content and the process ends.

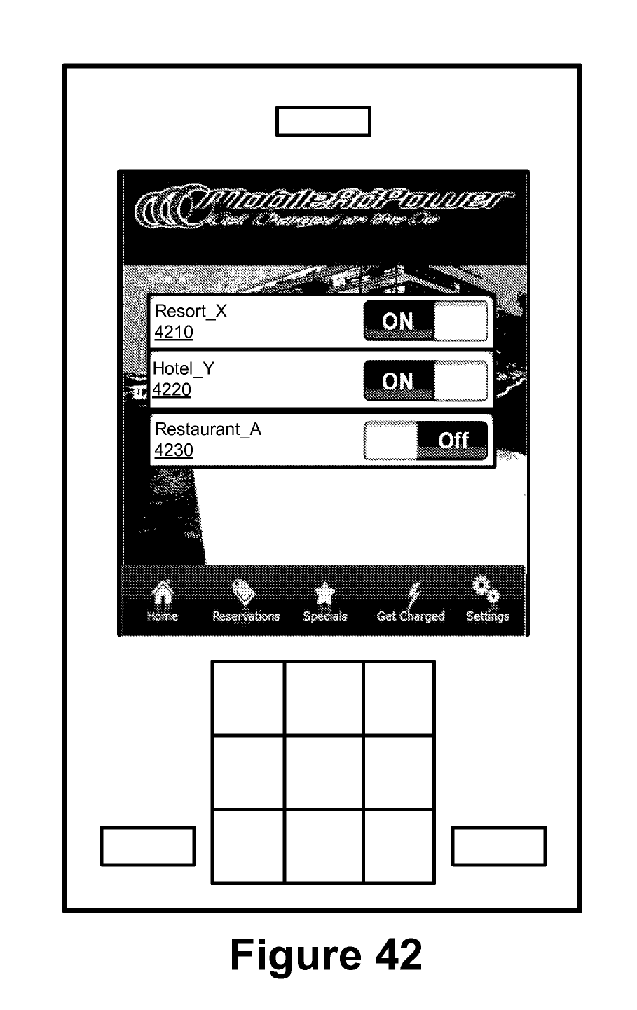

In some embodiments, the user can filter the content that is pushed to the mobile application. FIG. 42 presents a preferences display of the mobile application from which the user can specify which establishments are provided a passive presence in accordance with some embodiments. In this figure, the user can turn on and off notifications, advertisements, marketing promotions, and/or messages that are sent from a particular establishment using the icons 4210, 4220, and 4230. In some embodiments, the display of FIG. 42 is accessed using the “settings” button of FIG. 40.

VI. Electronic Device

Many of the above-described processes and modules are implemented as software processes that are specified as a set of instructions recorded on a computer readable storage medium (also referred to as computer readable medium). When these instructions are executed by one or more computational element(s) (such as processors or other computational elements like ASICs and FPGAs), they cause the computational element(s) to perform the actions indicated in the instructions. Electronic device, server, computer and computer system is meant in its broadest sense, and can include any electronic device with a processor including cellular telephones, smartphones, portable digital assistants, tablet devices, laptops, and netbooks. Examples of computer readable media include, but are not limited to, CD-ROMs, flash drives, RAM chips, hard drives, EPROMs, etc.

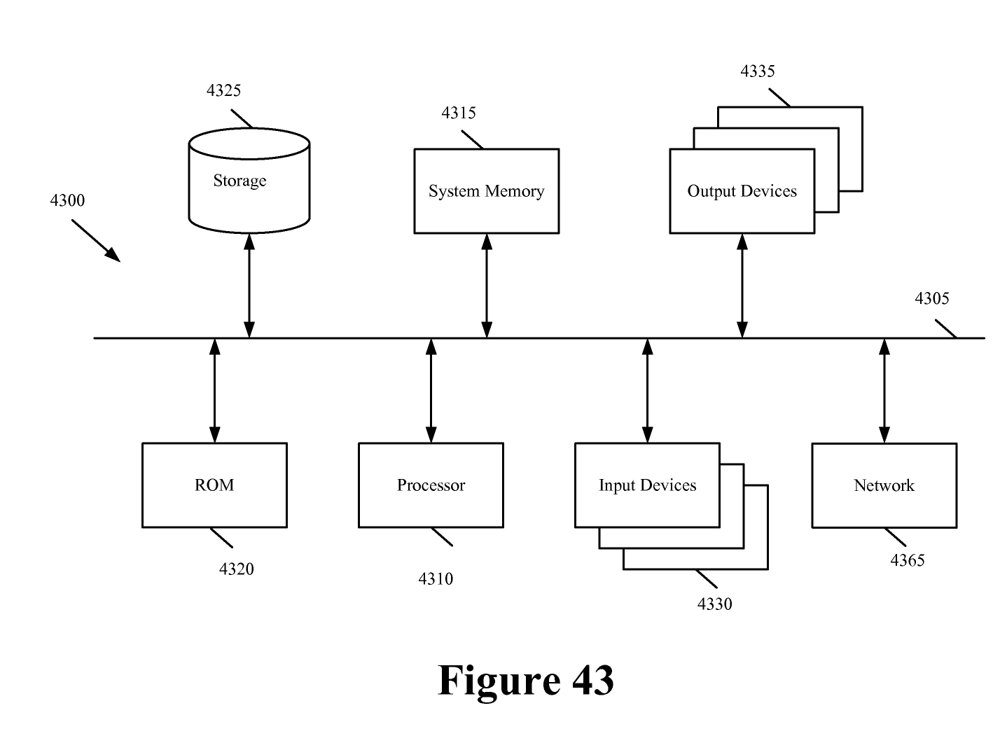

FIG. 43 illustrates an electronic device with which some embodiments are implemented. Such an electronic device includes various types of computer readable mediums and interfaces for various other types of computer readable mediums that implement the various processes and modules described above (e.g., the mobile application, the power distribution server processes, etc.). Electronic device 4300 includes a bus 4305, a processor 4310, a system memory 4315, a read-only memory 4320, a permanent storage device 4325, input devices 4330, and output devices 4335.

The bus 4305 collectively represents all system, peripheral, and chipset buses that communicatively connect the numerous internal devices of the computer system 4300. For instance, the bus 4305 communicatively connects the processor 4310 with the read-only memory 4320, the system memory 4315, and the permanent storage device 4325. From these various memory units, the processor 4310 retrieves instructions to execute and data to process in order to execute the processes of the invention. The processor 4310 is a processing device such as a central processing unit, integrated circuit, graphical processing unit, etc.

The read-only-memory (ROM) 4320 stores static data and instructions that are needed by the processor 4310 and other modules of the computer system. The permanent storage device 4325, on the other hand, is a read-and-write memory device. This device is a non-volatile memory unit that stores instructions and data even when the electronic device 4300 is off. Some embodiments of the invention use a mass-storage device (such as a magnetic or optical disk and its corresponding disk drive) as the permanent storage device 4325.

Other embodiments use a removable storage device (such as a flash drive) as the permanent storage device Like the permanent storage device 4325, the system memory 4315 is a read-and-write memory device. However, unlike storage device 4325, the system memory is a volatile read-and-write memory, such a random access memory (RAM). The system memory stores some of the instructions and data that the processor needs at runtime. In some embodiments, the processes are stored in the system memory 4315, the permanent storage device 4325, and/or the read-only memory 4320.

The bus 4305 also connects to the input and output devices 4330 and 4335. The input devices enable the user to communicate information and select commands to the computer system. The input devices 4330 include any of a capacitive touchscreen, resistive touchscreen, any other touchscreen technology, a touchpad that is part of the device or attached as a peripheral, a set of touch sensitive buttons or touch sensitive keys that are used to provide inputs to the device, or any other touch sensing hardware that detects multiple touches and that is coupled to the device or is attached as a peripheral. The input devices 4330 may also include alphanumeric keypads (including physical keyboards and touchscreen keyboards), pointing devices (also called “cursor control devices”). The output devices 4335 display images generated by the electronic device. For instance, these devices display the UI viewer symbols. The output devices include printers and display devices, such as cathode ray tubes (CRT) or liquid crystal displays (LCD).

Finally, as shown in FIG. 43, bus 4305 also couples electronic device 4300 to a network 4365 through a network adapter (not shown). In this manner, the electronic device 4300 can be a part of a network of devices (such as a local area network (“LAN”), a wide area network (“WAN”), or an Intranet, or a network of networks, such as the internet. For example, the electronic device 4300 may be coupled to a web server (network 4365) so that a web browser executing on the electronic device 4300 can interact with the web server as a user interacts with a GUI that operates in the web browser.

As mentioned above, the electronic device 4300 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

I claim:

1. A method for accessing power from a power station of a distributed power system, wherein the distributed power system comprises a plurality of power stations and a server for authorizing access to power of each power station, the method comprising:
providing an application that runs on an electronic device and that sends to the server a request to access power from a power station at a particular establishment;
receiving a message for enabling access to power of said power station; and
establishing a connection between said application and at least one server that hosts content for the particular establishment, said connection for passing, from the server to the application, content for the particular establishment.

2. The method of claim 1, wherein said application provides a wirelessly accessible platform to which the particular establishment sends marketing content to the user device.

3. The method of claim 1 further comprising displaying on the application content that is received from the server.

4. The method of claim 3 further comprising interacting with said content using the application, wherein interacting with said content comprises at least one of (i) requesting additional information that is related to said content and (ii) performing an e-commerce transaction to purchase a good or service that is identified by said content.

5. The method of claim 3, wherein the particular establishment is a first establishment, the method further comprising displaying content that is pushed to the application from a server that hosts content for a second establishment.

6. The method of claim 1, wherein the content for the particular establishment comprises at least one of (i) advertising content and (ii) promotional content for a good or service of at least one of the particular establishment and partners of the particular establishment.

7. The method of claim 1, wherein the content for the particular establishment comprises informational content for promoting the particular establishment.

8. The method of claim 1, wherein the particular establishment is a first establishment, the method further comprising sending a request using said application to request access to power from a power station at a second establishment and establishing a connection between said application and a server that hosts content for the second establishment, said connection for passing content that is provided by the server that hosts content for the second establishment to the application.

9. The method of claim 1 further comprising passing from the application identification information that identifies at least one of the electronic device, a user using the electronic device, and said application, wherein the server that hosts content for the particular establishment customizes content that is passed to the application based on the identification information.

10. The method of claim 1 further comprising identifying the user device, identifying an application from a plurality of applications based on the identified user device, and passing said application to the user device for execution on the user device.

11. The method of claim 1 further comprising passing from the application location information that identifies a location of the electronic device, wherein said location information is determined from at least one of (i) location based services of the electronic device, (ii) network triangulation of the user device, and (iii) a unique identifier that is associated with the power station.

12. The method of claim 11, wherein establishing the connection between said application and the server that hosts content for the particular establishment is based on the location information.

13. The method of claim 1 further comprising (i) identifying the electronic device, (ii) identifying an application from a plurality of applications to run on the identified electronic device, and (iii) passing said application for installation on the electronic device.

14. A method for utilizing a power distribution system comprising a plurality of portable power stations to provide a wirelessly accessible platform with which to connect to users, the method comprising:
activating a service provided by a power station of the plurality of power stations using an application that interfaces with the power distribution system, wherein said application runs on a user device;
presenting on the application, content for at least one of a good or a service that is affiliated with an establishment that hosts said power station;
monitoring user interactions with said content using the application; and
customizing the content that is presented on the application based on said monitored user interactions.

15. The method of claim 14 further comprising identifying the establishment that hosts said power station based on location information provided by the application to the power distribution system, wherein said location information comprises at least one of (i) Global Positioning System (GPS) coordinates, (ii) network triangulation positioning, and (iii) a unique identifier that is associated with the power station.

16. The method of claim 14, wherein monitoring user interactions comprises monitoring what content is selected by the user using the application.

17. The method of claim 14, wherein monitoring user interactions comprises monitoring an amount of time spent viewing a particular piece of content presented on the application.

18. The method of claim 14, wherein said content comprises at least one of advertising content and promotional content for a good or service that is affiliated with at least one of the establishment and a partner of the establishment.

19. The method of claim 14 further comprising logging said user interactions to provide a customized user experience at the establishment.

20. A computer readable storage medium storing a computer program for accessing power from a power station of a distributed power system, wherein the distributed power system comprises a plurality of power stations and a server for authorizing access to power of each power station, the computer program for execution by at least one processor, the computer program comprising:
a set of instructions for providing an application that runs on an electronic device and that sends to the server a request to access power from a power station at a particular establishment;
a set of instructions for receiving a message to enable access to power of said power station; and
a set of instructions for establishing a connection between said application and at least one server that hosts content for the particular establishment, said connection for passing, from the server to the application, content for the particular establishment.
